(19) United States
(12) Patent Application Publication
(10) Pub. No.: US 2020/0276511 A1
(43) Pub. Date: Sep. 3, 2020

(54) ULTRAFINE BUBBLE GENERATING APPARATUS, AND ULTRAFINE BUBBLE GENERATING METHOD

(71) Applicant: CANON KABUSHIKI KAISHA, Tokyo (JP)

(72) Inventors: Teruo Ozaki, Yokohama-shi (JP); Masahiko Kubota, Tokyo (JP); Akitoshi Yamada, Yokohama-shi (JP); Yoshiyuki Imanaka, Kawasaki-shi (JP); Yumi Yanai, Yokohama-shi (JP); Hiroshi Arimizu, Yotsukaido-shi (JP); Hiroyuki Ishinaga, Tokyo (JP)

(21) Appl. No.: 16/802,667

(22) Filed: Feb. 27, 2020

(30) Foreign Application Priority Data
Feb. 28, 2019 (JP) 2019-036508

(51) Int. Cl. B01B 1/00

(52) U.S. Cl. CPC B01B 1/00

(57) ABSTRACT

Provided are an ultrafine bubble generating apparatus and an ultrafine bubble generating method that can efficiently generate a UFB-containing liquid with high purity and can extend lifetime of the apparatus additionally. To this end, a shape of a bubble during generation thereof is partially restricted by forming walls around a heating element, and a position in which the bubble disappears is displaced from a position of the heating element.

### BACKGROUND OF THE INVENTION

### Field of the Invention

The present invention relates to an ultrafine bubble generating method and an ultrafine bubble generating apparatus for generating ultrafine bubbles smaller than 1.0 μm in diameter, and an ultrafine bubble-containing liquid.

### Description of the Related Art

Recently, there have been developed techniques for applying the features of fine bubbles such as microbubbles in micrometer-size in diameter and nanobubbles in nanometer-size in diameter. Especially, the utility of ultrafine bubbles (hereinafter also referred to as “UFBs”) smaller than 1.0 μm in diameter have been confirmed in various fields.

Japanese Patent No. 6118544 discloses a fine air bubble generating apparatus that generates fine bubbles by ejecting from a depressurizing nozzle a pressurized liquid in which a gas is pressurized and dissolved. Japanese Patent No. 4456176 discloses an apparatus that generates fine bubbles by repeating separating and converging of flows of a gas-mixed liquid with a mixing unit.

### SUMMARY OF THE INVENTION

The present invention is made to solve the above-described problems. Therefore, an object of the present invention is to provide an ultrafine bubble generating apparatus and an ultrafine bubble generating method capable of efficiently generating a UFB-containing liquid with high purity.

The ultrafine bubble generating apparatus of the present invention is an ultrafine bubble generating apparatus for generating ultrafine bubbles, including an element substrate that includes a plurality of heaters that generate the ultrafine bubbles by heating a liquid and a wiring connected with the heaters, wherein a restriction member that restricts a growth of a bubble generated by an action of each heater is included at least in a part of surroundings of the heater, and a first region having a predetermined area is provided between the restriction member and the heater.

Further features of the present invention will become apparent from the following description of exemplary embodiments with reference to the attached drawings.

### BRIEF DESCRIPTION OF THE DRAWINGS

FIG. 1 is a diagram illustrating an example of a UFB generating apparatus;

FIG. 2 is a schematic configuration diagram of a pre-processing unit;

FIGS. 3A and 3B are a schematic configuration diagram of a dissolving unit and a diagram for describing the dissolving states in a liquid;

FIG. 4 is a schematic configuration diagram of a T-UFB generating unit;

FIGS. 5A and 5B are diagrams for describing details of a heating element;

FIGS. 6A and 6B are diagrams for describing the states of film boiling on the heating element;

FIGS. 7A to 7D are diagrams illustrating the states of generation of UFBs caused by expansion of a film boiling bubble;

FIGS. 8A to 8C are diagrams illustrating the states of generation of UFBs caused by shrinkage of the film boiling bubble;

FIGS. 9A to 9C are diagrams illustrating the states of generation of UFBs caused by reheating of the liquid;

FIGS. 10A and 10B are diagrams illustrating the states of generation of UFBs caused by shock waves made by disappearance of the bubble generated by the film boiling;

FIGS. 11A to 11C are diagrams illustrating a configuration example of a post-processing unit;

FIGS. 12A and 12B are diagrams illustrating a chamber;

FIGS. 13A and 13B are diagrams illustrating an element substrate;

FIG. 14 is diagram illustrating an element substrate on which the walls are formed;

FIGS. 15A and 15B are diagrams illustrating a lid substrate;

FIGS. 16A and 16B are diagrams illustrating a supply pipe connected to a supply port and a discharge pipe connected to a discharge port;

FIGS. 17A and 17B are diagrams illustrating a state where an element substrate and flexible wiring substrates are electrically connected with each other;

FIGS. 18A to 18C are diagrams illustrating a heater part provided with a heating element;

FIGS. 19A to 19C are diagrams illustrating a state in which a liquid bubbles when a heating element is driven over time;

FIGS. 20A to 20K are diagrams illustrating a process of forming an element substrate in order of process;

FIGS. 21A to 21H are diagrams illustrating a process of forming an element substrate in order of process;

FIGS. 22A to 22D are diagrams illustrating a process of forming a chamber in order of process;

FIGS. 23A to 23C are diagrams illustrating a heater part on an element substrate; and

FIGS. 24A to 24C are diagrams illustrating a heater part on an element substrate.

### DESCRIPTION OF THE EMBODIMENTS

Both the apparatuses described in Japanese Patent Nos. 6118544 and 4456176 generate not only the UFBs of nanometer-size in diameter but also relatively a large number of milli-bubbles of millimeter-size in diameter and microbubbles of micrometer-size in diameter. However, because the milli-bubbles and the microbubbles are affected by the buoyancy, the bubbles are likely to gradually rise to the liquid surface and disappear during long-time storage.

On the other hand, the UFBs of nanometer-size in diameter are suitable for long-time storage since they are less likely to be affected by the buoyancy and float in the liquid with Brownian motion. However, when the UFBs are generated with the milli-bubbles and the microbubbles or the gas-liquid interface energy of the UFBs is small, the UFBs are affected by the disappearance of the milli-bubbles and the microbubbles and decreased over time. That is, in order to obtain a UFB-containing liquid in which the concentration reduction of the UFBs can be suppressed even during long-time storage, it is required to generate highly pure and highly concentrated UFBs with large gas-liquid interface energy when generating a UFB-containing liquid.

### <<Configuration of UFB Generating Apparatus>>

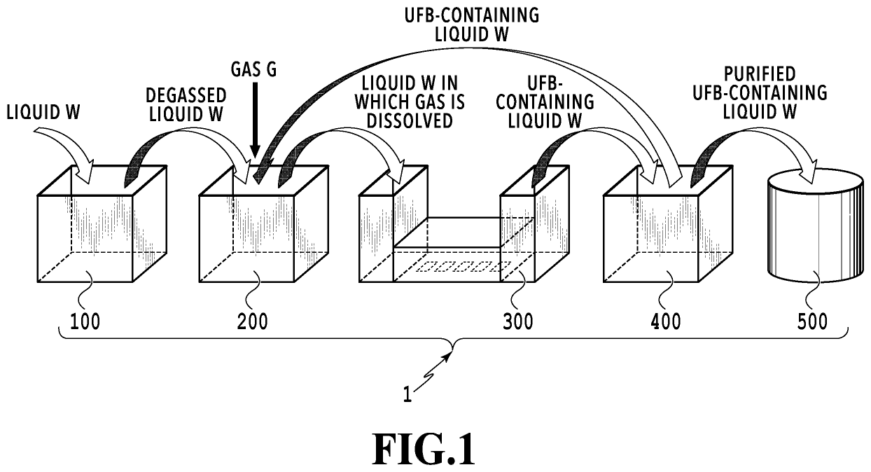

FIG. 1 is a diagram illustrating an example of a UFB generating apparatus applicable to the present invention. A UFB generating apparatus 1 of this embodiment includes a pre-processing unit 100, dissolving unit 200, a T-UFB generating unit 300, a post-processing unit 400, and a collecting unit 500. Each unit performs unique processing on a liquid W such as tap water supplied to the pre-processing unit 100 in the above order, and the thus-processed liquid W is collected as a T-UFB-containing liquid by the collecting unit 500. Functions and configurations of the units are described below. Although details are described later, UFBs generated by utilizing the film boiling caused by rapid heating are referred to as thermal-ultrafine bubbles (T-UFBs) in this specification.

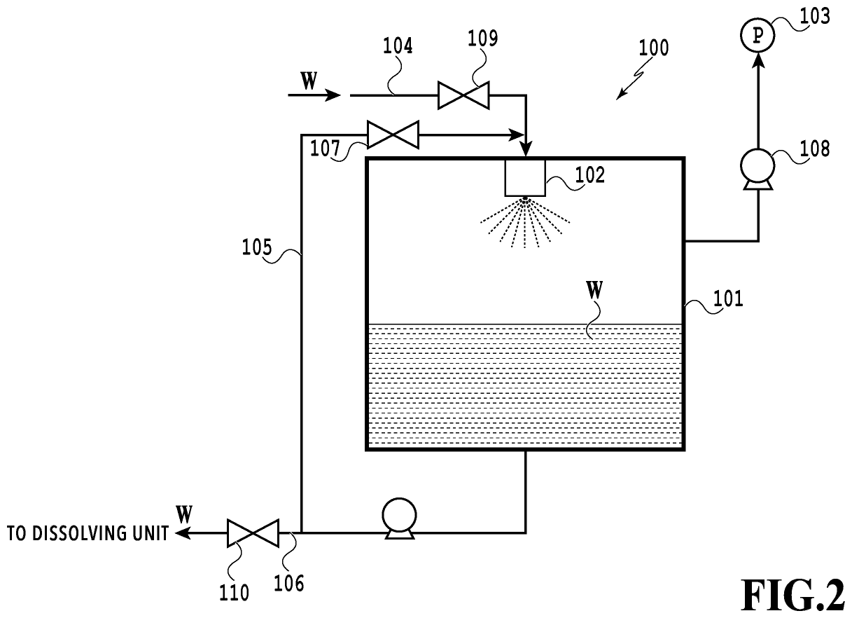

FIG. 2 is a schematic configuration diagram of the pre-processing unit 100. The pre-processing unit 100 of this embodiment performs a degassing treatment on the supplied liquid W. The pre-processing unit 100 mainly includes a degassing container 101, a shower head 102, a depressurizing pump 103, a liquid introduction passage 104, a liquid circulation passage 105, and a liquid discharge passage 106. For example, the liquid W such as tap water is supplied to the degassing container 101 from the liquid introduction passage 104 through a valve 109. In this process, the shower head 102 provided in the degassing container 101 sprays a mist of the liquid W in the degassing container 101. The shower head 102 is for prompting the gasification of the liquid W; however, a centrifugal and the like may be used instead as the mechanism for producing the gasification prompt effect.

When a certain amount of the liquid W is reserved in the degassing container 101 and then the depressurizing pump 103 is activated with all the valves closed, already-gasified gas components are discharged, and gasification and discharge of gas components dissolved in the liquid W are also prompted. In this process, the internal pressure of the degassing container 101 may be depressurized to around several hundreds to thousands of Pa (1.0 Torr to 10.0 Torr) while checking a manometer 108. The gases to be removed by the pre-processing unit 100 includes nitrogen, oxygen, argon, carbon dioxide, and so on, for example.

The above-described degassing processing can be repeatedly performed on the same liquid W by utilizing the liquid circulation passage 105. Specifically, the shower head 102 is operated with the valve 109 of the liquid introduction passage 104 and a valve 110 of the liquid discharge passage 106 closed and a valve 107 of the liquid circulation passage 105 opened. This allows the liquid W reserved in the degassing container 101 and degassed once to be resprayed in the degassing container 101 from the shower head 102. In addition, with the depressurizing pump 103 operated, the gasification processing by the shower head 102 and the degassing processing by the depressurizing pump 103 are repeatedly performed on the same liquid W. Every time the above processing utilizing the liquid circulation passage 105 is performed repeatedly, it is possible to decrease the gas components contained in the liquid W in stages. Once the liquid W degassed to a desired purity is obtained, the liquid W is transferred to the dissolving unit 200 through the liquid discharge passage 106 with the valve 110 opened.

FIG. 2 illustrates the degassing unit 100 that depressurizes the gas part to gasify the solute; however, the method of degassing the solution is not limited thereto. For example, a heating and boiling method for boiling the liquid W to gasify the solute may be employed, or a film degassing method for increasing the interface between the liquid and the gas using hollow fibers. A SEPAREL series (produced by DIC corporation) is commercially supplied as the degassing module using the hollow fibers. The SEPAREL series uses poly(4-methylpentene-1) (PMP) for the raw material of the hollow fibers and is used for removing air bubbles from ink and the like mainly supplied for a piezo head. In addition, two or more of an evacuating method, the heating and boiling method, and the film degassing method may be used together.

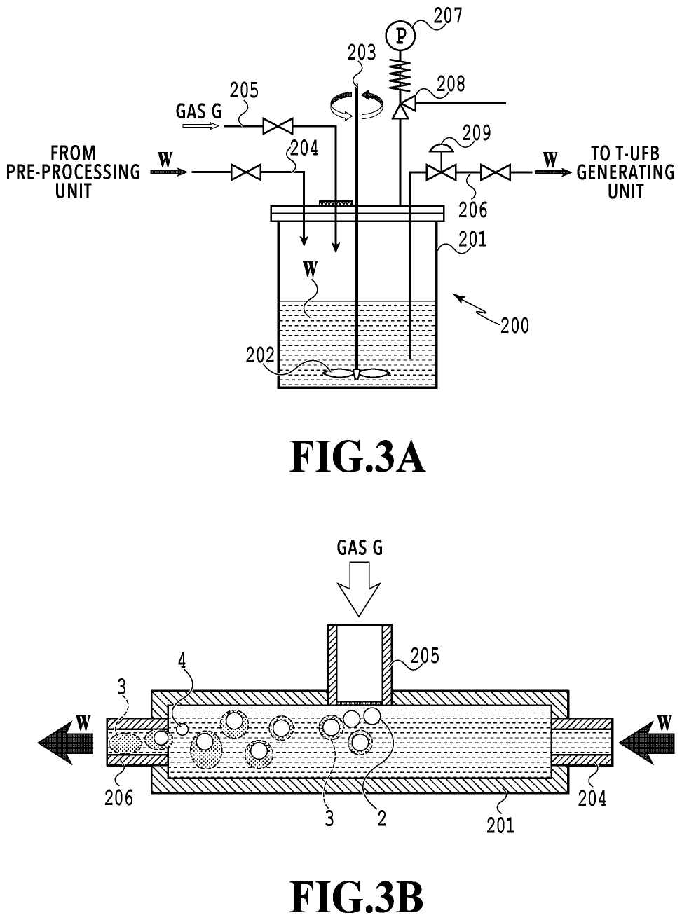

FIGS. 3A and 3B are a schematic configuration diagram of the dissolving unit 200 and a diagram for describing the dissolving states in the liquid. The dissolving unit 200 is a unit for dissolving a desired gas into the liquid W supplied from the pre-processing unit 100. The dissolving unit 200 of this embodiment mainly includes a dissolving container 201, a rotation shaft 203 provided with a rotation plate 202, a liquid introduction passage 204, a gas introduction passage 205, a liquid discharge passage 206, and a pressurizing pump 207.

The liquid W supplied from the pre-processing unit 100 is supplied and reserved into the dissolving container 201 through the liquid introduction passage 204. Meanwhile, a gas G is supplied to the dissolving container 201 through the gas introduction passage 205.

Once predetermined amounts of the liquid W and the gas G are reserved in the dissolving container 201, the pressurizing pump 207 is activated to increase the internal pressure of the dissolving container 201 to about 0.5 MPa. A safety valve 208 is arranged between the pressurizing pump 207 and the dissolving container 201. With the rotation plate 202 in the liquid rotated via the rotation shaft 203, the gas G supplied to the dissolving container 201 is transformed into air bubbles, and the contact area between the gas G and the liquid W is increased to prompt the dissolution into the liquid W. This operation is continued until the solubility of the gas G reaches almost the maximum saturation solubility. In this case, a unit for decreasing the temperature of the liquid may be provided to dissolve the gas as much as possible. When the gas is with low solubility, it is also possible to increase the internal pressure of the dissolving container 201 to 0.5 MPa or higher. In this case, the material and the like of the container need to be the optimum for safety sake.

Once the liquid Win which the components of the gas G are dissolved at a desired concentration is obtained, the liquid W is discharged through the liquid discharge passage 206 and supplied to the T-UFB generating unit 300. In this process, a back-pressure valve 209 adjusts the flow pressure of the liquid W to prevent excessive increase of the pressure during the supplying.

FIG. 3B is a diagram schematically illustrating the dissolving states of the gas G put in the dissolving container 201. An air bubble 2 containing the components of the gas G put in the liquid W is dissolved from a portion in contact with the liquid W. The air bubble 2 thus shrinks gradually, and a gas-dissolved liquid 3 then appears around the air bubble 2. Since the air bubble 2 is affected by the buoyancy, the air bubble 2 may be moved to a position away from the center of the gas-dissolved liquid 3 or be separated out from the gas-dissolved liquid 3 to become a residual air bubble 4. Specifically, in the liquid W to be supplied to the T-UFB generating unit 300 through the liquid discharge passage 206, there is a mix of the air bubbles 2 surrounded by the gas-dissolved liquids 3 and the air bubbles 2 and the gas-dissolved liquids 3 separated from each other.

The gas-dissolved liquid 3 in the drawings means “a region of the liquid W in which the dissolution concentration of the gas G mixed therein is relatively high.” In the gas components actually dissolved in the liquid W, the concentration of the gas components in the gas-dissolved liquid 3 is the highest at a portion surrounding the air bubble 2. In a case where the gas-dissolved liquid 3 is separated from the air bubble 2 the concentration of the gas components of the gas-dissolved liquid 3 is the highest at the center of the region, and the concentration is continuously decreased as away from the center. That is, although the region of the gas-dissolved liquid 3 is surrounded by a broken line in FIG. 3 for the sake of explanation, such a clear boundary does not actually exist. In addition, in the present invention, a gas that cannot be dissolved completely may be accepted to exist in the form of an air bubble in the liquid.

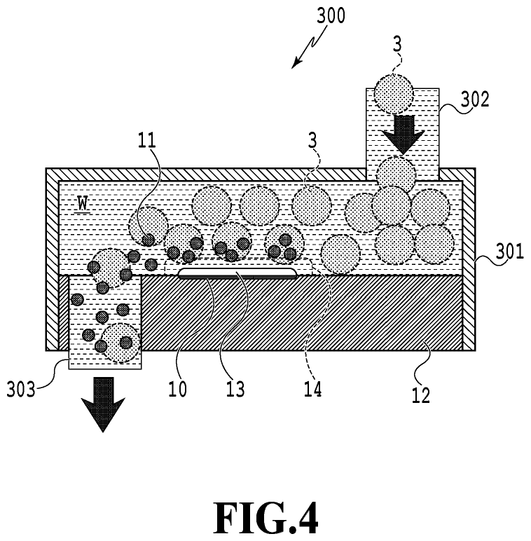

FIG. 4 is a schematic configuration diagram of the T-UFB generating unit 300. The T-UFB generating unit 300 mainly includes a chamber 301, a liquid introduction passage 302, and a liquid discharge passage 303. The flow from the liquid introduction passage 302 to the liquid discharge passage 303 through the chamber 301 is formed by a not-illustrated flow pump. Various pumps including a diaphragm pump, a gear pump, and a screw pump may be employed as the flow pump. In in the liquid W introduced from the liquid introduction passage 302, the gas-dissolved liquid 3 of the gas G put by the dissolving unit 200 is mixed.

An element substrate 12 provided with a heating element 10 is arranged on a bottom section of the chamber 301. With a predetermined voltage pulse applied to the heating element 10, a bubble 13 generated by the film boiling (hereinafter, also referred to as a film boiling bubble 13) is generated in a region in contact with the heating element 10. Then, an ultrafine bubble (UFB) 11 containing the gas G is generated caused by expansion and shrinkage of the film boiling bubble 13. As a result, a UFB-containing liquid W containing many UFBs 11 is discharged from the liquid discharge passage 303.

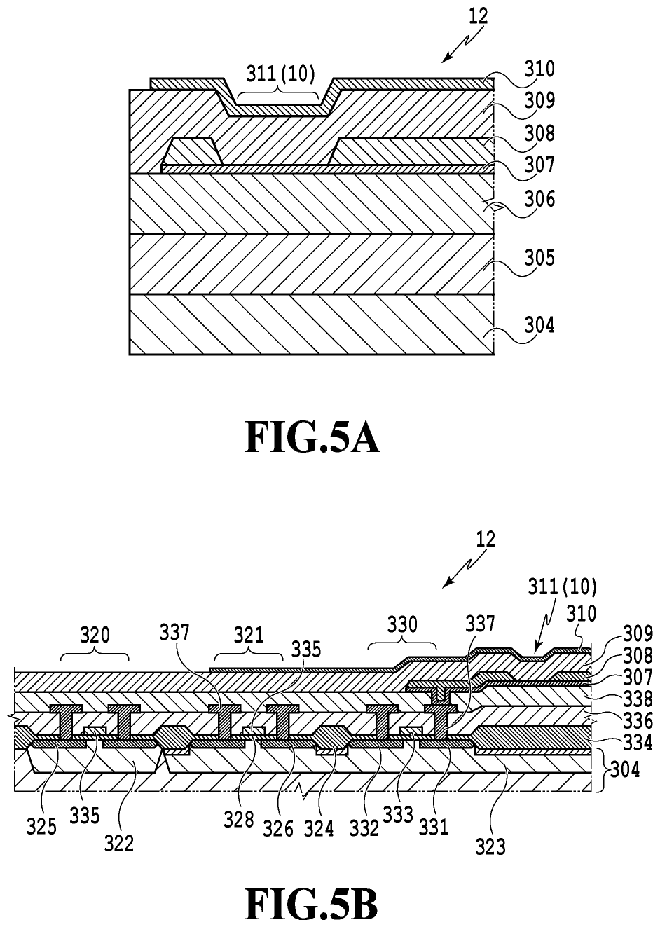

FIGS. 5A and 5B are diagrams for illustrating a detailed configuration of the heating element 10. FIG. 5A illustrates a closeup view of the heating element 10, and FIG. 5B illustrates a cross-sectional view of a wider region of the element substrate 12 including the heating element 10.

As illustrated in FIG. 5A, in the element substrate 12 of this embodiment, a thermal oxide film 305 as a heat-accumulating layer and an interlaminar film 306 also served as a heat-accumulating layer are laminated on a surface of a silicon substrate 304. An SiO2 film or an SiN film may be used as the interlaminar film 306. A resistive layer 307 is formed on a surface of the interlaminar film 306, and a wiring 308 is partially formed on a surface of the resistive layer 307. An Al-alloy wiring of Al, Al—Si, Al—Cu, or the like may be used as the wiring 308. A protective layer 309 made of an SiO2 film or an Si3N4 film is formed on surfaces of the wiring 308, the resistive layer 307, and the interlaminar film 306.

A cavitation-resistant film 310 for protecting the protective layer 309 from chemical and physical impacts due to the heat evolved by the resistive layer 307 is formed on a portion and around the portion on the surface of the protective layer 309, the portion corresponding to a heat-acting portion 311 that eventually becomes the heating element 10. A region on the surface of the resistive layer 307 in which the wiring 308 is not formed is the heat-acting portion 311 in which the resistive layer 307 evolves heat. The heating portion of the resistive layer 307 on which the wiring 308 is not formed functions as the heating element (heater) 10. As described above, the layers in the element substrate 12 are sequentially formed on the surface of the silicon substrate 304 by a semiconductor production technique, and the heat-acting portion 311 is thus provided on the silicon substrate 304.

The configuration illustrated in the drawings is an example, and various other configurations are applicable. For example, a configuration in which the laminating order of the resistive layer 307 and the wiring 308 is opposite, and a configuration in which an electrode is connected to a lower surface of the resistive layer 307 (so-called a plug electrode configuration) are applicable. In other words, as described later, any configuration may be applied as long as the configuration allows the heat-acting portion 311 to heat the liquid for generating the film boiling in the liquid.

FIG. 5B is an example of a cross-sectional view of a region including a circuit connected to the wiring 308 in the element substrate 12. An N-type well region 322 and a P-type well region 323 are partially provided in a top layer of the silicon substrate 304, which is a P-type conductor. AP-MOS 320 is formed in the N-type well region 322 and an N-MOS 321 is formed in the P-type well region 323 by introduction and diffusion of impurities by the ion implantation and the like in the general MOS process.

The P-MOS 320 includes a source region 325 and a drain region 326 formed by partial introduction of N-type or P-type impurities in a top layer of the N-type well region 322, a gate wiring 335, and so on. The gate wiring 335 is deposited on a part of a top surface of the N-type well region 322 excluding the source region 325 and the drain region 326, with a gate insulation film 328 of several hundreds of A in thickness interposed between the gate wiring 335 and the top surface of the N-type well region 322.

The N-MOS 321 includes the source region 325 and the drain region 326 formed by partial introduction of N-type or P-type impurities in a top layer of the P-type well region 323, the gate wiring 335, and so on. The gate wiring 335 is deposited on a part of a top surface of the P-type well region 323 excluding the source region 325 and the drain region 326, with the gate insulation film 328 of several hundreds of A in thickness interposed between the gate wiring 335 and the top surface of the P-type well region 323. The gate wiring 335 is made of polysilicon of 3000 Å to 5000 Å in thickness deposited by the CVD method. A C-MOS logic is constructed with the P-MOS 320 and the N-MOS 321.

In the P-type well region 323, an N-MOS transistor 330 for driving an electrothermal conversion element (heating resistance element) is formed on a portion different from the portion including the N-MOS 321. The N-MOS transistor 330 includes a source region 332 and a drain region 331 partially provided in the top layer of the P-type well region 323 by the steps of introduction and diffusion of impurities, a gate wiring 333, and so on. The gate wiring 333 is deposited on a part of the top surface of the P-type well region 323 excluding the source region 332 and the drain region 331, with the gate insulation film 328 interposed between the gate wiring 333 and the top surface of the P-type well region 323.

In this example, the N-MOS transistor 330 is used as the transistor for driving the electrothermal conversion element. However, the transistor for driving is not limited to the N-MOS transistor 330, and any transistor may be used as long as the transistor has a capability of driving multiple electrothermal conversion elements individually and can implement the above-described fine configuration. Although the electrothermal conversion element and the transistor for driving the electrothermal conversion element are formed on the same substrate in this example, those may be formed on different substrates separately.

An oxide film separation region 324 is formed by field oxidation of 5000 Å to 10000 Å in thickness between the elements, such as between the P-MOS 320 and the N-MOS 321 and between the N-MOS 321 and the N-MOS transistor 330. The oxide film separation region 324 separates the elements. A portion of the oxide film separation region 324 corresponding to the heat-acting portion 311 functions as a heat-accumulating layer 334, which is the first layer on the silicon substrate 304.

An interlayer insulation film 336 including a PSG film, a BPSG film, or the like of about 7000 Å in thickness is formed by the CVD method on each surface of the elements such as the P-MOS 320, the N-MOS 321, and the N-MOS transistor 330. After the interlayer insulation film 336 is made flat by heat treatment, an Al electrode 337 as a first wiring layer is formed in a contact hole penetrating through the interlayer insulation film 336 and the gate insulation film 328. On surfaces of the interlayer insulation film 336 and the Al electrode 337, an interlayer insulation film 338 including an SiO2 film of 10000 Å to 15000 Å in thickness is formed by a plasma CVD method. On the surface of the interlayer insulation film 338, a resistive layer 307 including a TaSiN film of about 500 Å in thickness is formed by a co-sputter method on portions corresponding to the heat-acting portion 311 and the N-MOS transistor 330. The resistive layer 307 is electrically connected with the Al electrode 337 near the drain region 331 via a through-hole formed in the interlayer insulation film 338. On the surface of the resistive layer 307, the wiring 308 of Al as a second wiring layer for a wiring to each electrothermal conversion element is formed. The protective layer 309 on the surfaces of the wiring 308, the resistive layer 307, and the interlayer insulation film 338 includes an SiN film of 3000 Å in thickness formed by the plasma CVD method. The cavitation-resistant film 310 deposited on the surface of the protective layer 309 includes a thin film of about 2000 Å in thickness, which is at least one metal selected from the group consisting of Ta, Fe, Ni, Cr, Ge, Ru, Zr, Ir, and the like. Various materials other than the above-described TaSiN such as TaN0.8, CrSiN, TaAl, WSiN, and the like can be applied as long as the material can generate the film boiling in the liquid.

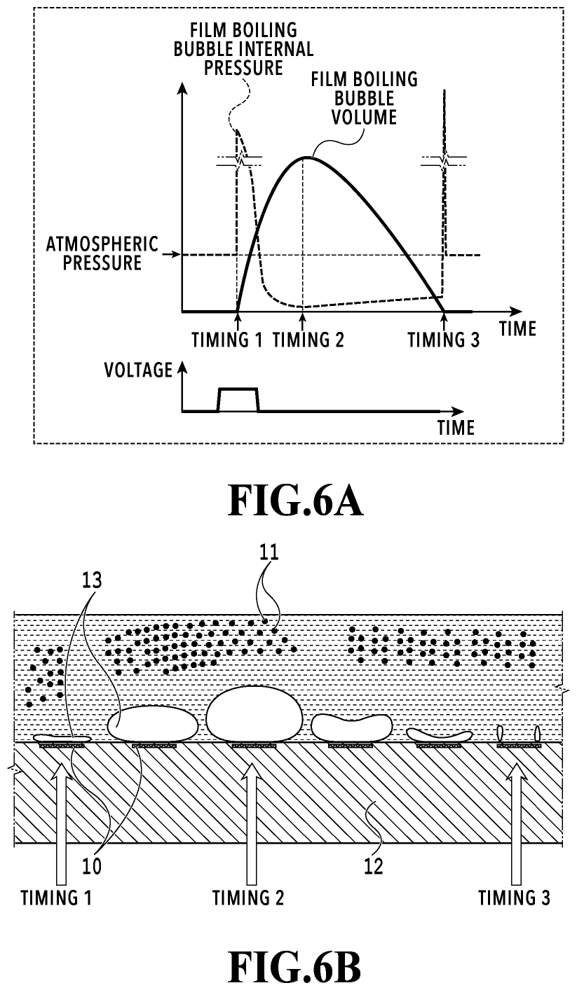

FIGS. 6A and 6B are diagrams illustrating the states of the film boiling when a predetermined voltage pulse is applied to the heating element 10. In this case, the case of generating the film boiling under atmospheric pressure is described. In FIG. 6A, the horizontal axis represents time. The vertical axis in the lower graph represents a voltage applied to the heating element 10, and the vertical axis in the upper graph represents the volume and the internal pressure of the film boiling bubble 13 generated by the film boiling. On the other hand, FIG. 6B illustrates the states of the film boiling bubble 13 in association with timings 1 to 3 shown in FIG. 6A. Each of the states is described below in chronological order. The UFBs 11 generated by the film boiling as described later are mainly generated near a surface of the film boiling bubble 13. The states illustrated in FIG. 6B are the states where the UFBs 11 generated by the generating unit 300 are resupplied to the dissolving unit 200 through the circulation route, and the liquid containing the UFBs 11 is resupplied to the liquid passage of the generating unit 300, as illustrated in FIG. 1.

Before a voltage is applied to the heating element 10, the atmospheric pressure is substantially maintained in the chamber 301. Once a voltage is applied to the heating element 10, the film boiling is generated in the liquid in contact with the heating element 10, and a thus-generated air bubble (hereinafter, referred to as the film boiling bubble 13) is expanded by a high pressure acting from inside (timing 1). A bubbling pressure in this process is expected to be around 8 to 10 MPa, which is a value close to a saturation vapor pressure of water.

The time for applying a voltage (pulse width) is around 0.5 μsec to 10.0 μsec, and the film boiling bubble 13 is expanded by the inertia of the pressure obtained in timing 1 even after the voltage application. However, a negative pressure generated with the expansion is gradually increased inside the film boiling bubble 13, and the negative pressure acts in a direction to shrink the film boiling bubble 13. After a while, the volume of the film boiling bubble 13 becomes the maximum in timing 2 when the inertial force and the negative pressure are balanced, and thereafter the film boiling bubble 13 shrinks rapidly by the negative pressure.

In the disappearance of the film boiling bubble 13, the film boiling bubble 13 disappears not in the entire surface of the heating element 10 but in one or more extremely small regions. For this reason, on the heating element 10, further greater force than that in the bubbling in timing 1 is generated in the extremely small region in which the film boiling bubble 13 disappears (timing 3).

The generation, expansion, shrinkage, and disappearance of the film boiling bubble 13 as described above are repeated every time a voltage pulse is applied to the heating element 10, and new UFBs 11 are generated each time.

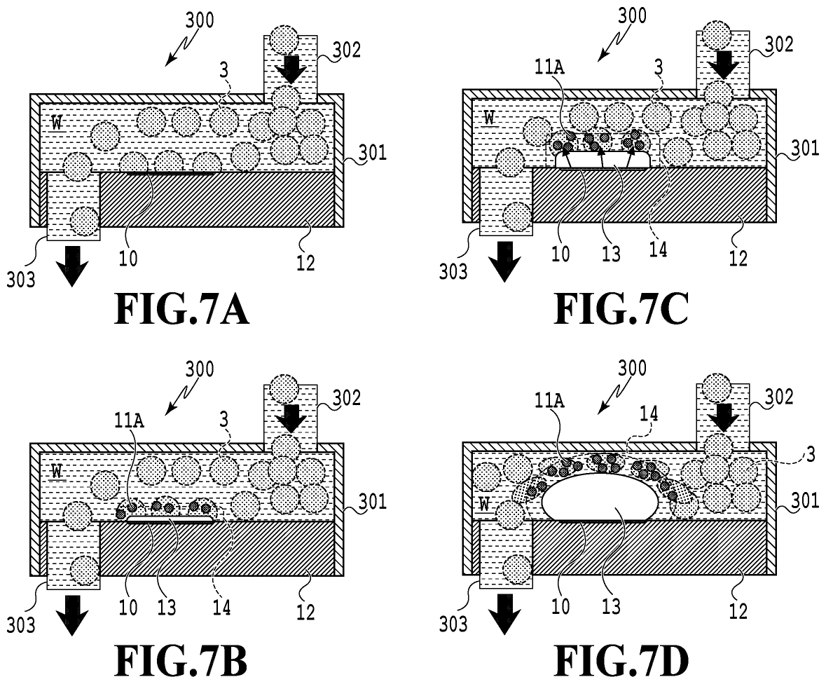

The states of generation of the UFBs 11 in each process of the generation, expansion, shrinkage, and disappearance of the film boiling bubble 13 are further described in detail with reference to FIGS. 7A to 10B.

FIGS. 7A to 7D are diagrams schematically illustrating the states of generation of the UFBs 11 caused by the generation and the expansion of the film boiling bubble 13. FIG. 7A illustrates the state before the application of a voltage pulse to the heating element 10. The liquid W in which the gas-dissolved liquids 3 are mixed flows inside the chamber 301.

FIG. 7B illustrates the state where a voltage is applied to the heating element 10, and the film boiling bubble 13 is evenly generated in almost all over the region of the heating element 10 in contact with the liquid W. When a voltage is applied, the surface temperature of the heating element 10 rapidly increases at a speed of 10° C./μsec. The film boiling occurs at a time point when the temperature reaches almost 300° C., and the film boiling bubble 13 is thus generated.

Thereafter, the surface temperature of the heating element 10 keeps increasing to around 600 to 800° C. during the pulse application, and the liquid around the film boiling bubble 13 is rapidly heated as well. In FIG. 7B, a region of the liquid that is around the film boiling bubble 13 and to be rapidly heated is indicated as a not-yet-bubbling high temperature region 14. The gas-dissolved liquid 3 within the not-yet-bubbling high temperature region 14 exceeds the thermal dissolution limit and is vaporized to become the UFB. The thus-vaporized air bubbles have diameters of around 10 nm to 100 nm and large gas-liquid interface energy. Thus, the air bubbles float independently in the liquid W without disappearing in a short time. In this embodiment, the air bubbles generated by the thermal action from the generation to the expansion of the film boiling bubble 13 are called first UFBs 11A.

FIG. 7C illustrates the state where the film boiling bubble 13 is expanded. Even after the voltage pulse application to the heating element 10, the film boiling bubble 13 continues expansion by the inertia of the force obtained from the generation thereof, and the not-yet-bubbling high temperature region 14 is also moved and spread by the inertia. Specifically, in the process of the expansion of the film boiling bubble 13, the gas-dissolved liquid 3 within the not-yet-bubbling high temperature region 14 is vaporized as a new air bubble and becomes the first UFB 11A.

FIG. 7D illustrates the state where the film boiling bubble 13 has the maximum volume. As the film boiling bubble 13 is expanded by the inertia, the negative pressure inside the film boiling bubble 13 is gradually increased along with the expansion, and the negative pressure acts to shrink the film boiling bubble 13. At a time point when the negative pressure and the inertial force are balanced, the volume of the film boiling bubble 13 becomes the maximum, and then the shrinkage is started.

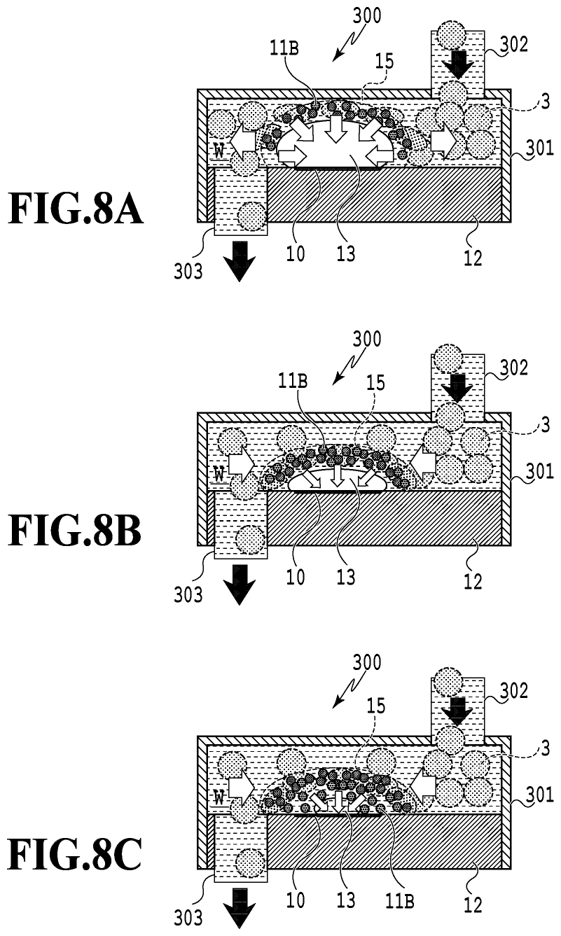

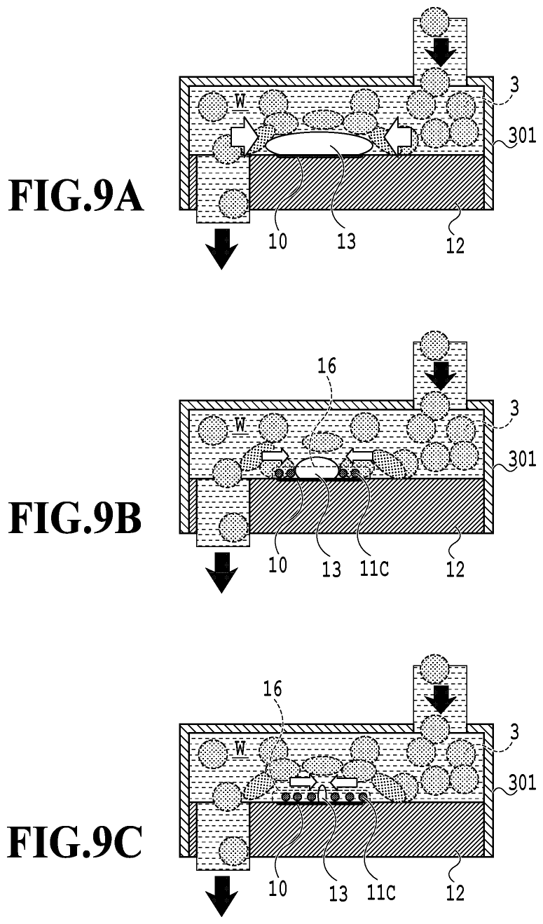

In the shrinking stage of the film boiling bubble 13, there are UFBs generated by the processes illustrated in FIGS. 8A to 8C (second UFBs 11B) and UFBs generated by the processes illustrated in FIGS. 9A to 9C (third UFBs 11C). It is considered that these two processes are made simultaneously.

FIGS. 8A to 8C are diagrams illustrating the states of generation of the UFBs 11 caused by the shrinkage of the film boiling bubble 13. FIG. 8A illustrates the state where the film boiling bubble 13 starts shrinking. Although the film boiling bubble 13 starts shrinking, the surrounding liquid W still has the inertial force in the expansion direction. Because of this, the inertial force acting in the direction of going away from the heating element 10 and the force going toward the heating element 10 caused by the shrinkage of the film boiling bubble 13 act in a surrounding region extremely close to the film boiling bubble 13, and the region is depressurized. The region is indicated in the drawings as a not-yet-bubbling negative pressure region 15.

The gas-dissolved liquid 3 within the not-yet-bubbling negative pressure region 15 exceeds the pressure dissolution limit and is vaporized to become an air bubble. The thus-vaporized air bubbles have diameters of about 100 nm and thereafter float independently in the liquid W without disappearing in a short time. In this embodiment, the air bubbles vaporized by the pressure action during the shrinkage of the film boiling bubble 13 are called the second UFBs 11B.

FIG. 8B illustrates a process of the shrinkage of the film boiling bubble 13. The shrinking speed of the film boiling bubble 13 is accelerated by the negative pressure, and the not-yet-bubbling negative pressure region 15 is also moved along with the shrinkage of the film boiling bubble 13. Specifically, in the process of the shrinkage of the film boiling bubble 13, the gas-dissolved liquids 3 within a part over the not-yet-bubbling negative pressure region 15 are precipitated one after another and become the second UFBs 11B.

FIG. 8C illustrates the state immediately before the disappearance of the film boiling bubble 13. Although the moving speed of the surrounding liquid W is also increased by the accelerated shrinkage of the film boiling bubble 13, a pressure loss occurs due to a flow passage resistance in the chamber 301. As a result, the region occupied by the not-yet-bubbling negative pressure region 15 is further increased, and a number of the second UFBs 11B are generated.

FIGS. 9A to 9C are diagrams illustrating the states of generation of the UFBs by reheating of the liquid W during the shrinkage of the film boiling bubble 13. FIG. 9A illustrates the state where the surface of the heating element 10 is covered with the shrinking film boiling bubble 13.

FIG. 9B illustrates the state where the shrinkage of the film boiling bubble 13 has progressed, and a part of the surface of the heating element 10 comes in contact with the liquid W. In this state, there is heat left on the surface of the heating element 10, but the heat is not high enough to cause the film boiling even if the liquid W comes in contact with the surface. A region of the liquid to be heated by coming in contact with the surface of the heating element 10 is indicated in the drawings as a not-yet-bubbling reheated region 16. Although the film boiling is not made, the gas-dissolved liquid 3 within the not-yet-bubbling reheated region 16 exceeds the thermal dissolution limit and is vaporized. In this embodiment, the air bubbles generated by the reheating of the liquid W during the shrinkage of the film boiling bubble 13 are called the third UFBs 11C.

FIG. 9C illustrates the state where the shrinkage of the film boiling bubble 13 has further progressed. The smaller the film boiling bubble 13, the greater the region of the heating element 10 in contact with the liquid W, and the third UFBs 11C are generated until the film boiling bubble 13 disappears.

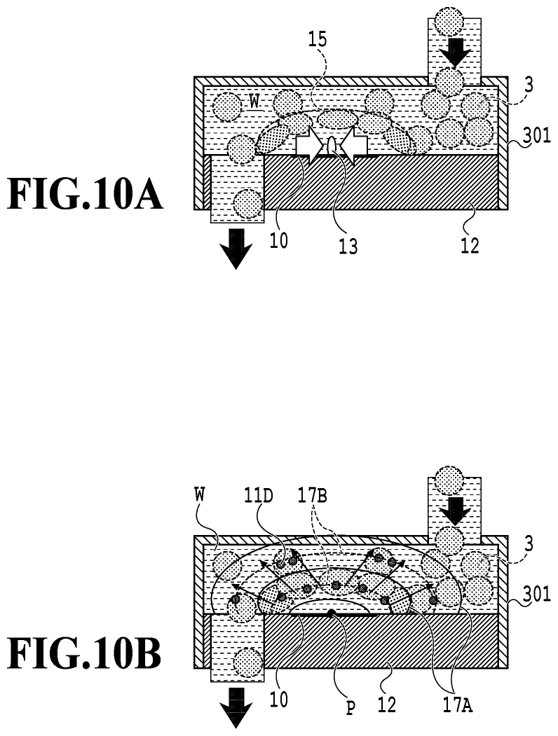

FIGS. 10A and 10B are diagrams illustrating the states of generation of the UFBs caused by an impact from the disappearance of the film boiling bubble 13 generated by the film boiling (that is, a type of cavitation). FIG. 10A illustrates the state immediately before the disappearance of the film boiling bubble 13. In this state, the film boiling bubble 13 shrinks rapidly by the internal negative pressure, and the not-yet-bubbling negative pressure region 15 surrounds the film boiling bubble 13.

FIG. 10B illustrates the state immediately after the film boiling bubble 13 disappears at a point P. When the film boiling bubble 13 disappears, acoustic waves ripple concentrically from the point P as a starting point due to the impact of the disappearance. The acoustic wave is a collective term of an elastic wave that is propagated through anything regardless of gas, liquid, and solid. In this embodiment, compression waves of the liquid W, which are a high pressure surface 17A and a low pressure surface 17B of the liquid W, are propagated alternately.

In this case, the gas-dissolved liquid 3 within the not-yet-bubbling negative pressure region 15 is resonated by the shock waves made by the disappearance of the film boiling bubble 13, and the gas-dissolved liquid 3 exceeds the pressure dissolution limit and the phase transition is made in timing when the low pressure surface 17B passes therethrough. Specifically, a number of air bubbles are vaporized in the not-yet-bubbling negative pressure region 15 simultaneously with the disappearance of the film boiling bubble 13. In this embodiment, the air bubbles generated by the shock waves made by the disappearance of the film boiling bubble 13 are called fourth UFBs 11D.

The fourth UFBs 11D generated by the shock waves made by the disappearance of the film boiling bubble 13 suddenly appear in an extremely short time (1 μS or less) in an extremely narrow thin film-shaped region. The diameter is sufficiently smaller than that of the first to third UFBs, and the gas-liquid interface energy is higher than that of the first to third UFBs. For this reason, it is considered that the fourth UFBs 11D have different characteristics from the first to third UFBs 11A to 11C and generate different effects.

Additionally, the fourth UFBs 11D are evenly generated in many parts of the region of the concentric sphere in which the shock waves are propagated, and the fourth UFBs 11D evenly exist in the chamber 301 from the generation thereof. Although many first to third UFBs already exist in the timing of the generation of the fourth UFBs 11D, the presence of the first to third UFBs does not affect the generation of the fourth UFBs 11D greatly. It is also considered that the first to third UFBs do not disappear due to the generation of the fourth UFBs 11D.

As described above, it is expected that the UFBs 11 are generated in the multiple stages from the generation to the disappearance of the film boiling bubble 13 by the heat generation of the heating element 10. The first UFBs 11A, the second UFBs 11B, and the third UFBs 11C are generated near the surface of the film boiling bubble generated by the film boiling. In this case, near means a region within about 20 μm from the surface of the film boiling bubble. The fourth UFBs 11D are generated in a region through which the shock waves are propagated when the air bubble disappears. Although the above example illustrates the stages to the disappearance of the film boiling bubble 13, the way of generating the UFBs is not limited thereto. For example, with the generated film boiling bubble 13 communicating with the atmospheric air before the bubble disappearance, the UFBs can be generated also if the film boiling bubble 13 does not reach the disappearance.

Next, remaining properties of the UFBs are described. The higher the temperature of the liquid, the lower the dissolution properties of the gas components, and the lower the temperature, the higher the dissolution properties of the gas components. In other words, the phase transition of the dissolved gas components is prompted and the generation of the UFBs becomes easier as the temperature of the liquid is higher. The temperature of the liquid and the solubility of the gas are in the inverse relationship, and the gas exceeding the saturation solubility is transformed into air bubbles and appeared in the liquid as the liquid temperature increases.

Therefore, when the temperature of the liquid rapidly increases from normal temperature, the dissolution properties are decreased without stopping, and the generation of the UFBs starts. The thermal dissolution properties are decreased as the temperature increases, and a number of the UFBs are generated.

Conversely, when the temperature of the liquid decreases from normal temperature, the dissolution properties of the gas are increased, and the generated UFBs are more likely to be liquefied. However, such temperature is sufficiently lower than normal temperature. Additionally, since the once generated UFBs have a high internal pressure and large gas-liquid interface energy even when the temperature of the liquid decreases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the first UFBs 11A described with FIGS. 7A to 7C and the third UFBs 11C described with FIGS. 9A to 9C can be described as UFBs that are generated by utilizing such thermal dissolution properties of gas.

On the other hand, in the relationship between the pressure and the dissolution properties of liquid, the higher the pressure of the liquid, the higher the dissolution properties of the gas, and the lower the pressure, the lower the dissolution properties. In other words, the phase transition to the gas of the gas-dissolved liquid dissolved in the liquid is prompted and the generation of the UFBs becomes easier as the pressure of the liquid is lower. Once the pressure of the liquid becomes lower than normal pressure, the dissolution properties are decreased instantly, and the generation of the UFBs starts. The pressure dissolution properties are decreased as the pressure decreases, and a number of the UFBs are generated.

Conversely, when the pressure of the liquid increases to be higher than normal temperature, the dissolution properties of the gas are increased, and the generated UFBs are more likely to be liquefied. However, such pressure is sufficiently higher than the atmospheric pressure. Additionally, since the once generated UFBs have a high internal pressure and large gas-liquid interface energy even when the pressure of the liquid increases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the second UFBs 11B described with FIGS. 8A to 8C and the fourth UFBs 11D described with FIGS. 10A to 10C can be described as UFBs that are generated by utilizing such pressure dissolution properties of gas.

Those first to fourth UFBs generated by different causes are described individually above; however, the above-described generation causes occur simultaneously with the event of the film boiling. Thus, at least two types of the first to the fourth UFBs may be generated at the same time, and these generation causes may cooperate to generate the UFBs. It should be noted that it is common for all the generation causes to be induced by the volume change of the film boiling bubble generated by the film boiling phenomenon. In this specification, the method of generating the UFBs by utilizing the film boiling caused by the rapid heating as described above is referred to as a thermal-ultrafine bubble (T-UFB) generating method. Additionally, the UFBs generated by the T-UFB generating method are referred to as T-UFBs, and the liquid containing the T-UFBs generated by the T-UFB generating method is referred to as a T-UFB-containing liquid.

Almost all the air bubbles generated by the T-UFB generating method are 1.0 μm or less, and milli-bubbles and microbubbles are unlikely to be generated. That is, the T-UFB generating method allows dominant and efficient generation of the UFBs. Additionally, the T-UFBs generated by the T-UFB generating method have larger gas-liquid interface energy than that of the UFBs generated by a conventional method, and the T-UFBs do not disappear easily as long as being stored at normal temperature and normal pressure. Moreover, even if new T-UFBs are generated by new film boiling, it is possible to prevent disappearance of the already generated T-UFBs due to the impact from the new generation. That is, it can be said that the number and the concentration of the T-UFBs contained in the T-UFB-containing liquid have the hysteresis properties depending on the number of times the film boiling is made in the T-UFB-containing liquid. In other words, it is possible to adjust the concentration of the T-UFBs contained in the T-UFB-containing liquid by controlling the number of the heating elements provided in the T-UFB generating unit 300 and the number of the voltage pulse application to the heating elements.

Reference to FIG. 1 is made again. Once the T-UFB-containing liquid W with a desired UFB concentration is generated in the T-UFB generating unit 300, the UFB-containing liquid W is supplied to the post-processing unit 400.

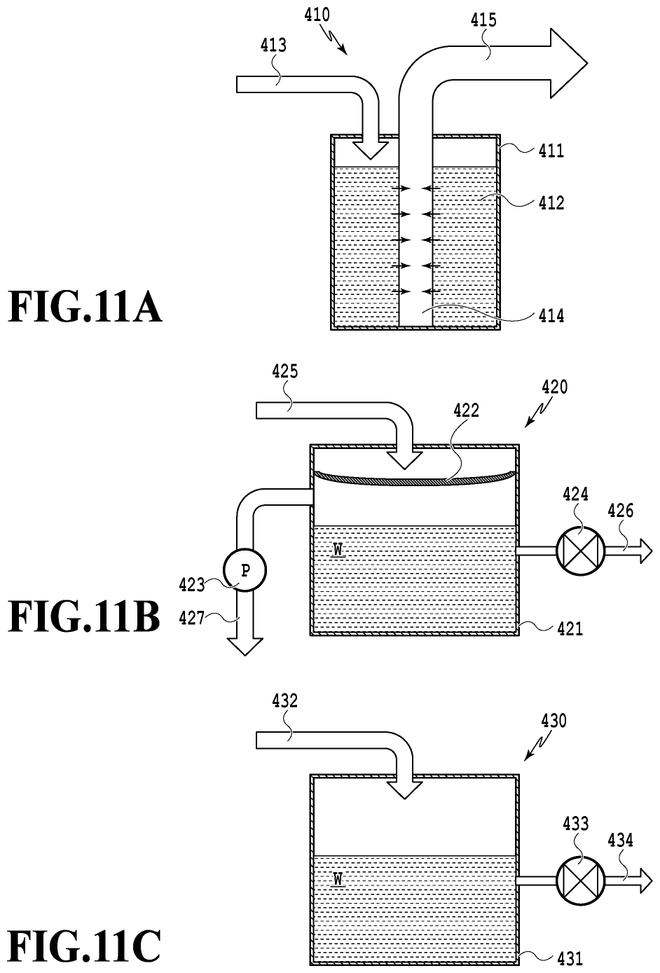

FIGS. 11A to 11C are diagrams illustrating configuration examples of the post-processing unit 400 of this embodiment. The post-processing unit 400 of this embodiment removes impurities in the UFB-containing liquid W in stages in the order from inorganic ions, organic substances, and insoluble solid substances.

FIG. 11A illustrates a first post-processing mechanism 410 that removes the inorganic ions. The first post-processing mechanism 410 includes an exchange container 411, cation exchange resins 412, a liquid introduction passage 413, a collecting pipe 414, and a liquid discharge passage 415. The exchange container 411 stores the cation exchange resins 412. The UFB-containing liquid W generated by the T-UFB generating unit 300 is injected to the exchange container 411 through the liquid introduction passage 413 and absorbed into the cation exchange resins 412 such that the cations as the impurities are removed. Such impurities include metal materials peeled off from the element substrate 12 of the T-UFB generating unit 300, such as SiO2, SiN, SiC, Ta, Al2O3, Ta2O5, and Ir.

The cation exchange resins 412 are synthetic resins in which a functional group (ion exchange group) is introduced in a high polymer matrix having a three-dimensional network, and the appearance of the synthetic resins are spherical particles of around 0.4 to 0.7 mm. A general high polymer matrix is the styrene-divinylbenzene copolymer, and the functional group may be that of methacrylic acid series and acrylic acid series, for example. However, the above material is an example. As long as the material can remove desired inorganic ions effectively, the above material can be changed to various materials. The UFB-containing liquid W absorbed in the cation exchange resins 412 to remove the inorganic ions is collected by the collecting pipe 414 and transferred to the next step through the liquid discharge passage 415. In this process in the present embodiment, not all the inorganic ions contained in the UFB-containing liquid W supplied from the liquid introduction passage 413 need to be removed as long as at least a part of the inorganic ions are removed.

FIG. 11B illustrates a second post-processing mechanism 420 that removes the organic substances. The second post-processing mechanism 420 includes a storage container 421, a filtration filter 422, a vacuum pump 423, a valve 424, a liquid introduction passage 425, a liquid discharge passage 426, and an air suction passage 427. Inside of the storage container 421 is divided into upper and lower two regions by the filtration filter 422. The liquid introduction passage 425 is connected to the upper region of the upper and lower two regions, and the air suction passage 427 and the liquid discharge passage 426 are connected to the lower region thereof. Once the vacuum pump 423 is driven with the valve 424 closed, the air in the storage container 421 is discharged through the air suction passage 427 to make the pressure inside the storage container 421 negative pressure, and the UFB-containing liquid W is thereafter introduced from the liquid introduction passage 425. Then, the UFB-containing liquid W from which the impurities are removed by the filtration filter 422 is reserved into the storage container 421.

The impurities removed by the filtration filter 422 include organic materials that may be mixed at a tube or each unit, such as organic compounds including silicon, siloxane, and epoxy, for example. A filter film usable for the filtration filter 422 includes a filter of a sub-μm-mesh (a filter of 1 μm or smaller in mesh diameter) that can remove bacteria, and a filter of a nm-mesh that can remove virus. The filtration filter having such a fine opening diameter may remove air bubbles larger than the opening diameter of the filter. Particularly, there may be the case where the filter is clogged by the fine air bubbles adsorbed to the openings (mesh) of the filter, which may slowdown the filtering speed. However, as described above, most of the air bubbles generated by the T-UFB generating method described in the present embodiment of the invention are in the size of 1 μm or smaller in diameter, and milli-bubbles and microbubbles are not likely to be generated. That is, since the probability of generating milli-bubbles and microbubbles is extremely low, it is possible to suppress the slowdown in the filtering speed due to the adsorption of the air bubbles to the filter. For this reason, it is favorable to apply the filtration filter 422 provided with the filter of 1 μm or smaller in mesh diameter to the system having the T-UFB generating method.

Examples of the filtration applicable to this embodiment may be a so-called dead-end filtration and cross-flow filtration. In the dead-end filtration, the direction of the flow of the supplied liquid and the direction of the flow of the filtration liquid passing through the filter openings are the same, and specifically, the directions of the flows are made along with each other. In contrast, in the cross-flow filtration, the supplied liquid flows in a direction along a filter surface, and specifically, the direction of the flow of the supplied liquid and the direction of the flow of the filtration liquid passing through the filter openings are crossed with each other. It is preferable to apply the cross-flow filtration to suppress the adsorption of the air bubbles to the filter openings.

After a certain amount of the UFB-containing liquid W is reserved in the storage container 421, the vacuum pump 423 is stopped and the valve 424 is opened to transfer the T-UFB-containing liquid in the storage container 421 to the next step through the liquid discharge passage 426. Although the vacuum filtration method is employed as the method of removing the organic impurities herein, a gravity filtration method and a pressurized filtration can also be employed as the filtration method using a filter, for example.

FIG. 11C illustrates a third post-processing mechanism 430 that removes the insoluble solid substances. The third post-processing mechanism 430 includes a precipitation container 431, a liquid introduction passage 432, a valve 433, and a liquid discharge passage 434.

First, a predetermined amount of the UFB-containing liquid W is reserved into the precipitation container 431 through the liquid introduction passage 432 with the valve 433 closed, and leaving it for a while. Meanwhile, the solid substances in the UFB-containing liquid W are precipitated onto the bottom of the precipitation container 431 by gravity. Among the bubbles in the UFB-containing liquid, relatively large bubbles such as microbubbles are raised to the liquid surface by the buoyancy and also removed from the UFB-containing liquid. After a lapse of sufficient time, the valve 433 is opened, and the UFB-containing liquid W from which the solid substances and large bubbles are removed is transferred to the collecting unit 500 through the liquid discharge passage 434. The example of applying the three post-processing mechanisms in sequence is shown in this embodiment; however, it is not limited thereto, and the order of the three post-processing mechanisms may be changed, or at least one needed post-processing mechanism may be employed.

Reference to FIG. 1 is made again. The T-UFB-containing liquid W from which the impurities are removed by the post-processing unit 400 may be directly transferred to the collecting unit 500 or may be put back to the dissolving unit 200 again to form a circulation system. In the latter case, the gas dissolution concentration of the T-UFB-containing liquid W that is decreased due to the generation of the T-UFBs can be increased. Preferably the gas dissolution concentration of the T-UFB-containing liquid W that is decreased the reduced gas dissolution concentration of the T-UFB-containing liquid W can be compensated to the saturated state again by the dissolving unit 200. If new T-UFBs are generated by the T-UFB generating unit 300 after the compensation, it is possible to further increase the concentration of the UFBs contained in the T-UFB-containing liquid with the above-described properties. That is, it is possible to increase the concentration of the contained UFBs by the number of circulations through the dissolving unit 200, the T-UFB generating unit 300, and the post-processing unit 400, and it is possible to transfer the UFB-containing liquid W to the collecting unit 500 after a predetermined concentration of the contained UFBs is obtained. This embodiment shows a form in which the UFB-containing liquid processed by the post-processing unit 400 is put back to the dissolving unit 200 and circulated; however, it is not limited thereto, and the UFB-containing liquid after passing through the T-UFB generating unit may be put back again to the dissolving unit 200 before being supplied to the post-processing unit 400 such that the post-processing is performed by the post-processing unit 400 after the T-UFB concentration is increased through multiple times of circulation, for example.

The collecting unit 500 collects and preserves the UFB-containing liquid W transferred from the post-processing unit 400. The T-UFB-containing liquid collected by the collecting unit 500 is a UFB-containing liquid with high purity from which various impurities are removed.

In the collecting unit 500, the UFB-containing liquid W may be classified by the size of the T-UFBs by performing some stages of filtration processing. Since it is expected that the temperature of the T-UFB-containing liquid W obtained by the T-UFB method is higher than normal temperature, the collecting unit 500 may be provided with a cooling unit. The cooling unit may be provided to a part of the post-processing unit 400.

The schematic description of the UFB generating apparatus 1 is given above; however, it is needless to say that the illustrated multiple units can be changed, and not all of them need to be prepared. Depending on the type of the liquid W and the gas G to be used and the intended use of the T-UFB-containing liquid to be generated, a part of the above-described units may be omitted, or another unit other than the above-described units may be added.

For example, when the gas to be contained by the UFBs is the atmospheric air, the degassing unit as the pre-processing unit 100 and the dissolving unit 200 can be omitted. On the other hand, when multiple kinds of gases are desired to be contained by the UFBs, another dissolving unit 200 may be added.

The units for removing the impurities as described in FIGS. 11A to 11C may be provided upstream of the T-UFB generating unit 300 or may be provided both upstream and downstream thereof. When the liquid to be supplied to the UFB generating apparatus is tap water, rain water, contaminated water, or the like, there may be included organic and inorganic impurities in the liquid. If such a liquid W including the impurities is supplied to the T-UFB generating unit 300, there is a risk of deteriorating the heating element 10 and inducing the salting-out phenomenon. With the mechanisms as illustrated in FIGS. 11A to 11C provided upstream of the T-UFB generating unit 300, it is possible to remove the above-described impurities previously.

### <<Liquid and Gas Usable for T-UFB-Containing Liquid>>

Now, the liquid W usable for generating the T-UFB-containing liquid is described. The liquid W usable in this embodiment is, for example, pure water, ion exchange water, distilled water, bioactive water, magnetic active water, lotion, tap water, sea water, river water, clean and sewage water, lake water, underground water, rain water, and so on. A mixed liquid containing the above liquid and the like is also usable. A mixed solvent containing water and soluble organic solvent can be also used. The soluble organic solvent to be used by being mixed with water is not particularly limited; however, the followings can be a specific example thereof. An alkyl alcohol group of the carbon number of 1 to 4 including methyl alcohol, ethyl alcohol, n-propyl alcohol, isopropyl alcohol, n-butyl alcohol, sec-butyl alcohol, and tert-butyl alcohol. An amide group including N-methyl-2-pyrrolidone, 2-pyrrolidone, 1,3-dimethyl-2-imidazolidinone, N,N-dimethylformamide, and N,N-dimethylacetamide. A keton group or a ketoalcohol group including acetone and diacetone alcohol. A cyclic ether group including tetrahydrofuran and dioxane. A glycol group including ethylene glycol, 1,2-propylene glycol, 1,3-propylene glycol, 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, and thiodiglycol. A group of lower alkyl ether of polyhydric alcohol including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether. A polyalkylene glycol group including polyethylene glycol and polypropylene glycol. A triol group including glycerin, 1,2,6-hexanetriol, and trimethylolpropane. These soluble organic solvents can be used individually, or two or more of them can be used together.

A gas component that can be introduced into the dissolving unit 200 is, for example, hydrogen, helium, oxygen, nitrogen, methane, fluorine, neon, carbon dioxide, ozone, argon, chlorine, ethane, propane, air, and so on. The gas component may be a mixed gas containing some of the above. Additionally, it is not necessary for the dissolving unit 200 to dissolve a substance in a gas state, and the dissolving unit 200 may fuse a liquid or a solid containing desired components into the liquid W. The dissolution in this case may be spontaneous dissolution, dissolution caused by pressure application, or dissolution caused by hydration, ionization, and chemical reaction due to electrolytic dissociation.

### <<Effects of T-UFB Generating Method>>

Next, the characteristics and the effects of the above-described T-UFB generating method are described by comparing with a conventional UFB generating method. For example, in a conventional air bubble generating apparatus as represented by the Venturi method, a mechanical depressurizing structure such as a depressurizing nozzle is provided in a part of a flow passage. A liquid flows at a predetermined pressure to pass through the depressurizing structure, and air bubbles of various sizes are generated in a downstream region of the depressurizing structure.

In this case, among the generated air bubbles, since the relatively large bubbles such as milli-bubbles and microbubbles are affected by the buoyancy, such bubbles rise to the liquid surface and disappear. Even the UFBs that are not affected by the buoyancy may also disappear with the milli-bubbles and microbubbles since the gas-liquid interface energy of the UFBs is not very large. Additionally, even if the above-described depressurizing structures are arranged in series, and the same liquid flows through the depressurizing structures repeatedly, it is impossible to store for a long time the UFBs of the number corresponding to the number of repetitions. In other words, it has been difficult for the UFB-containing liquid generated by the conventional UFB generating method to maintain the concentration of the contained UFBs at a predetermined value for a long time.

In contrast, in the T-UFB generating method of this embodiment utilizing the film boiling, a rapid temperature change from normal temperature to about 300° C. and a rapid pressure change from normal pressure to around a several megapascal occur locally in a part extremely close to the heating element. The heating element is a rectangular shape having one side of around several tens to hundreds of μm. It is around 1/10 to 1/1000 of the size of a conventional UFB generating unit. Additionally, with the gas-dissolved liquid within the extremely thin film region of the film boiling bubble surface exceeding the thermal dissolution limit or the pressure dissolution limit instantaneously (in an extremely short time under microseconds), the phase transition occurs and the gas-dissolved liquid is precipitated as the UFBs. In this case, the relatively large bubbles such as milli-bubbles and microbubbles are hardly generated, and the liquid contains the UFBs of about 100 nm in diameter with extremely high purity. Moreover, since the T-UFBs generated in this way have sufficiently large gas-liquid interface energy, the T-UFBs are not broken easily under the normal environment and can be stored for a long time.

Particularly, the present invention using the film boiling phenomenon that enables local formation of a gas interface in the liquid can form an interface in a part of the liquid close to the heating element without affecting the entire liquid region, and a region on which the thermal and pressure actions performed can be extremely local. As a result, it is possible to stably generate desired UFBs. With further more conditions for generating the UFBs applied to the generation liquid through the liquid circulation, it is possible to additionally generate new UFBs with small effects on the already-made UFBs. As a result, it is possible to produce a UFB liquid of a desired size and concentration relatively easily.

Moreover, since the T-UFB generating method has the above-described hysteresis properties, it is possible to increase the concentration to a desired concentration while keeping the high purity. In other words, according to the T-UFB generating method, it is possible to efficiently generate a long-time storable UFB-containing liquid with high purity and high concentration.

### <<Specific Usage of T-UFB-Containing Liquid>>

In general, applications of the ultrafine bubble-containing liquids are distinguished by the type of the containing gas. Any type of gas can make the UFBs as long as an amount of around PPM to BPM of the gas can be dissolved in the liquid. For example, the ultrafine bubble-containing liquids can be applied to the following applications.
A UFB-containing liquid containing air can be preferably applied to cleansing in the industrial, agricultural and fishery, and medical scenes and the like, and to cultivation of plants and agricultural and fishery products.
A UFB-containing liquid containing ozone can be preferably applied to not only cleansing application in the industrial, agricultural and fishery, and medical scenes and the like, but to also applications intended to disinfection, sterilization, and decontamination, and environmental cleanup of drainage and contaminated soil, for example.
A UFB-containing liquid containing nitrogen can be preferably applied to not only cleansing application in the industrial, agricultural and fishery, and medical scenes and the like, but to also applications intended to disinfection, sterilization, and decontamination, and environmental cleanup of drainage and contaminated soil, for example.
A UFB-containing liquid containing oxygen can be preferably applied to cleansing application in the industrial, agricultural and fishery, and medical scenes and the like, and to cultivation of plants and agricultural and fishery products.
A UFB-containing liquid containing carbon dioxide can be preferably applied to not only cleansing application in the industrial, agricultural and fishery, and medical scenes and the like, but to also applications intended to disinfection, sterilization, and decontamination, for example.
A UFB-containing liquid containing perfluorocarbons as a medical gas can be preferably applied to ultrasonic diagnosis and treatment. As described above, the UFB-containing liquids can exert the effects in various fields of medical, chemical, dental, food, industrial, agricultural and fishery, and so on.

In each of the applications, the purity and the concentration of the UFBs contained in the UFB-containing liquid are important for quickly and reliably exert the effect of the UFB-containing liquid. In other words, unprecedented effects can be expected in various fields by utilizing the T-UFB generating method of this embodiment that enables generation of the UFB-containing liquid with high purity and desired concentration. Here is below a list of the applications in which the T-UFB generating method and the T-UFB-containing liquid are expected to be preferably applicable.

### (A) Liquid Purification Application

With the T-UFB generating unit provided to a water clarification unit, enhancement of an effect of water clarification and an effect of purification of PH adjustment liquid is expected. The T-UFB generating unit may also be provided to a carbonated water server.
With the T-UFB generating unit provided to a humidifier, aroma diffuser, coffee maker, and the like, enhancement of a humidifying effect, a deodorant effect, and a scent spreading effect in a room is expected.
If the UFB-containing liquid in which an ozone gas is dissolved by the dissolving unit is generated and is used for dental treatment, burn treatment, and wound treatment using an endoscope, enhancement of a medical cleansing effect and an antiseptic effect is expected.
With the T-UFB generating unit provided to a water storage tank of a condominium, enhancement of a water clarification effect and chlorine removing effect of drinking water to be stored for a long time is expected.
If the T-UFB-containing liquid containing ozone or carbon dioxide is used for brewing process of Japanese sake, shochu, wine, and so on in which the high-temperature pasteurization processing cannot be performed, more efficient pasteurization processing than that with the conventional liquid is expected.
If the UFB-containing liquid is mixed into the ingredient in a production process of the foods for specified health use and the foods with functional claims, the pasteurization processing is possible, and thus it is possible to provide safe and functional foods without a loss of flavor.
With the T-UFB generating unit provided to a supplying route of sea water and fresh water for cultivation in a cultivation place of fishery products such as fish and pearl, prompting of spawning and growing of the fishery products is expected.
With the T-UFB generating unit provided in a purification process of water for food preservation, enhancement of the preservation state of the food is expected.
With the T-UFB generating unit provided in a bleaching unit for bleaching pool water or underground water, a higher bleaching effect is expected.
With the T-UFB-containing liquid used for repairing a crack of a concrete member, enhancement of the effect of crack repairment is expected.
With the T-UFBs contained in liquid fuel for a machine using liquid fuel (such as automobile, vessel, and airplane), enhancement of energy efficiency of the fuel is expected.

### (B) Cleansing Application

Recently, the UFB-containing liquids have been receiving attention as cleansing water for removing soils and the like attached to clothing. If the T-UFB generating unit described in the above embodiment is provided to a washing machine, and the UFB-containing liquid with higher purity and better permeability than the conventional liquid is supplied to the washing tub, further enhancement of detergency is expected.
With the T-UFB generating unit provided to a bath shower and a bedpan washer, not only a cleansing effect on all kinds of animals including human body but also an effect of prompting contamination removal of a water stain and a mold on a bathroom and a bedpan are expected.
With the T-UFB generating unit provided to a window washer for automobiles, a high-pressure washer for cleansing wall members and the like, a car washer, a dishwasher, a food washer, and the like, further enhancement of the cleansing effects thereof is expected.
With the T-UFB-containing liquid used for cleansing and maintenance of parts produced in a factory including a burring step after pressing, enhancement of the cleansing effect is expected.
In production of semiconductor elements, if the T-UFB-containing liquid is used as polishing water for a wafer, enhancement of the polishing effect is expected. Additionally, if the T-UFB-containing liquid is used in a resist removal step, prompting of peeling of resist that is not peeled off easily is enhanced.
With the T-UFB generating unit is provided to machines for cleansing and decontaminating medical machines such as a medical robot, a dental treatment unit, an organ preservation container, and the like, enhancement of the cleansing effect and the decontamination effect of the machines is expected. The T-UFB generating unit is also applicable to treatment of animals.

### (C) Pharmaceutical Application

If the T-UFB-containing liquid is contained in cosmetics and the like, permeation into subcutaneous cells is prompted, and additives that give bad effects to skin such as preservative and surfactant can be reduced greatly. As a result, it is possible to provide safer and more functional cosmetics.
If a high concentration nanobubble preparation containing the T-UFBs is used for contrasts for medical examination apparatuses such as a CT and an MRI, reflected light of X-rays and ultrasonic waves can be efficiently used. This makes it possible to capture a more detailed image that is usable for initial diagnosis of a cancer and the like.
If a high concentration nanobubble water containing the T-UFBs is used for a ultrasonic wave treatment machine called high-intensity focused ultrasound (HIFU), the irradiation power of ultrasonic waves can be reduced, and thus the treatment can be made more non-invasive. Particularly, it is possible to reduce the damage to normal tissues.
It is possible to create a nanobubble preparation by using high concentration nanobubbles containing the T-UFBs as a source, modifying a phospholipid forming a liposome in a negative electric charge region around the air bubble, and applying various medical substances (such as DNA and RNA) through the phospholipid.
If a drug containing high concentration nanobubble water made by the T-UFB generation is transferred into a dental canal for regenerative treatment of pulp and dentine, the drug enters deeply a dentinal tubule by the permeation effect of the nanobubble water, and the decontamination effect is prompted. This makes it possible to treat the infected root canal of the pulp safely in a short time.

Hereinafter, characteristics of the present application of the invention are described.

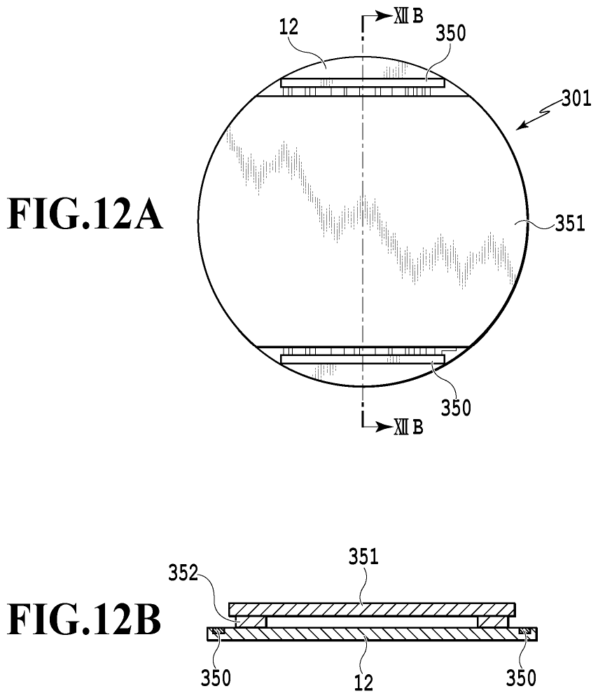

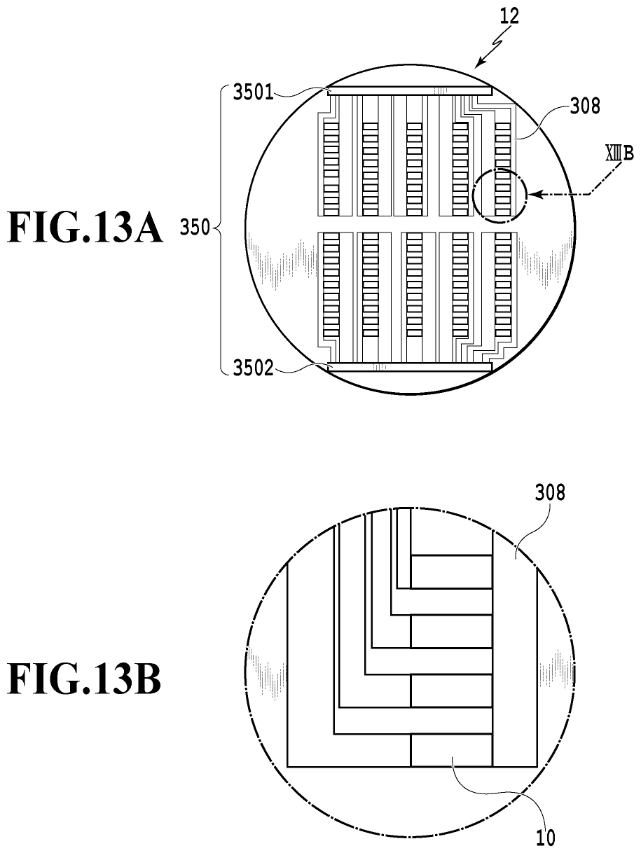

FIG. 12A is a diagram illustrating a chamber 301 that is a part of the T-UFB generating unit 300 in this embodiment, and FIG. 12B is a cross-sectional view taken along the XIIb-XIIb line in FIG. 12A. The chamber 301 of this embodiment is formed by providing walls 352 on the element substrate 12 formed of a silicon substrate in the form of a wafer on which the later-described heating elements 10 (see FIG. 13B) and wirings 308 (see FIGS. 13A and 13B) are formed, and by attaching a lid substrate 351 on the tops of the walls 352. Specifically, the chamber 301 forms and provides a space in which the heating elements 10 are located (see FIG. 13B). The silicon substrate in the form of a wafer is a substrate of a silicon wafer formed by slicing a single crystal ingot of silicon and is a substrate on which no cutting by dicing or the like is performed after slicing.

In the chamber 301, electrode pads 350 used for supplying power from outside to the element substrate 12 are provided at a distance from the chamber 301 by the walls 352. As described above, the chamber 301 of this embodiment has a simple configuration in which the walls 352 are formed on the element substrate 12 and the lid substrate 351 is attached on the tops of the walls 352.

FIG. 13A is a diagram illustrating the element substrate 12, and FIG. 13B is an enlarged view of FIG. 13A. In the element substrate 12 of this embodiment, there are formed the multiple heating elements 10, the wirings 308 supplying power to the heating elements 10, and the electrode pads 350 for connecting the wirings 308 with external wirings. In this embodiment, as described above, the element substrate 12 is not made into a chip and is used in the form of a wafer.

Two electrode pads including an electrode pad 3501 and an electrode pad 3502 are provided as the electrode pads 350 on the element substrate 12, while the electrode pad 3501 is provided in one end portion of the element substrate 12 and the electrode pad 3502 is provided in the other end portion opposing the one end portion. The wirings 308 are each connected with the corresponding heating elements 10 and either one of the two electrode pads 350. In such arrangement of the electrode pads 350, the lengths of the wirings from the heating elements 10 to the electrode pads 350 are different from each other. That is, the heating element 10 connected to one of the electrode pads 350 by a long wiring and the heating element 10 connected to one of the electrode pads 350 by a short wiring are provided on the element substrate 12. In this case, the wiring resistances between the electrode pads 350 and the heating elements 10 differ from each other depending on the difference between the lengths of the wirings, and voltage drops according to the lengths of the wirings occur during energization.

To deal with this, in this embodiment, the widths of the wirings differ from each other taking into consideration the differences between the distances from the electrode pads 350 to the heating elements 10. That is, the wirings are formed to have wider wiring widths as the distance from the electrode pad 350 to the heating element 10 is longer. This allows the configuration in which the voltage drops among the wirings to be substantially equal.

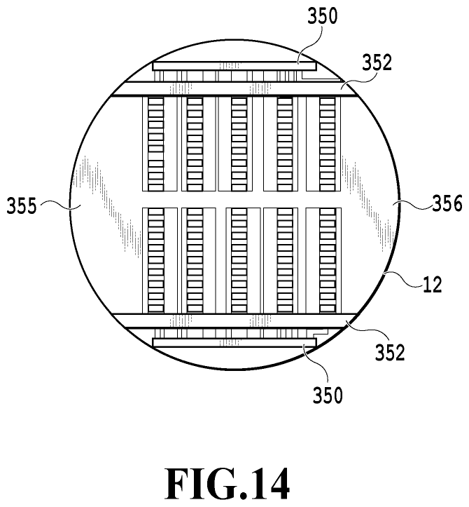

FIG. 14 is a diagram illustrating the element substrate 12 on which the walls 352 are formed. The walls 352 are formed by photolithography to form a part of the chamber 301. The walls 352 make a distance between the chamber 301 and the electrode pads 350 in the end portions of the element substrate 12. Since the capacity of the chamber 301 is determined according to the heights of the walls 352, it is desirable to determine the heights of the walls 352 based on the flow rate of the liquid flowing through the chamber 301 as necessary. The chamber 301 is formed by attaching the lid substrate 351 on the tops of these walls 352. With the lid substrate 351 attached to the walls 352, a supply port 355 for supplying the liquid to the chamber 301 and a discharge port 356 for discharging the liquid from the chamber 301 are formed. The liquid flowed in the chamber 301 from the supply port 355 flows over the element substrate 12 between the walls 352 and is discharged from the discharge port 356.

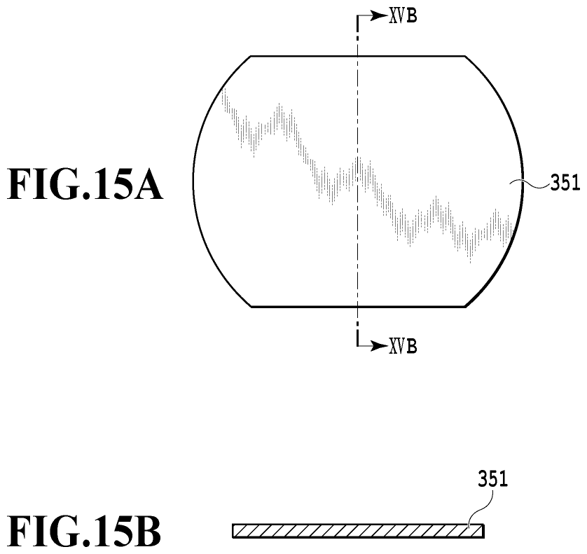

FIG. 15A is a front view illustrating the lid substrate 351, and FIG. 15B is a cross-sectional view taken along the XVb-XVb line in FIG. 15A. The lid substrate 351 is formed of a substrate made of silicon and is attached on the tops of the walls 352 to form the chamber 301. Although a substrate made of silicon is employed as the lid substrate 351 in this embodiment, the embodiment is not limited thereto, and a substrate formed of a material other than silicon may be adopted.

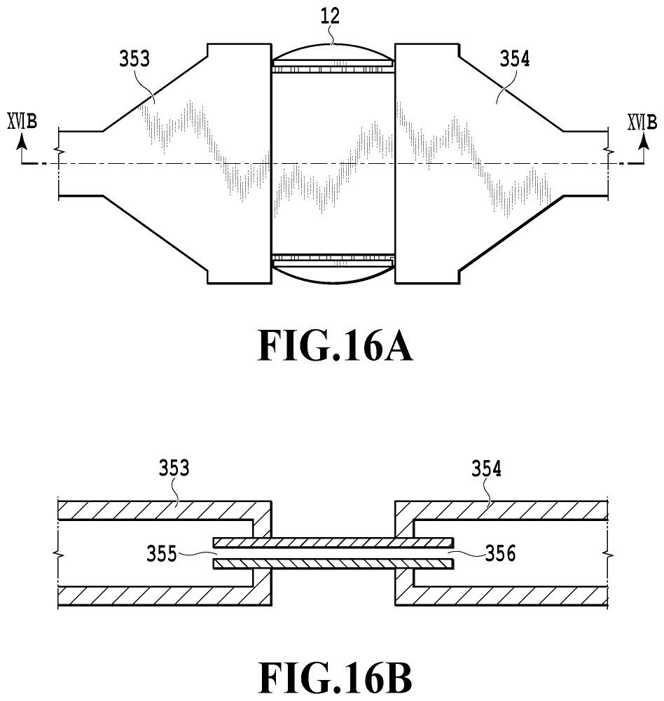

FIG. 16A is a diagram illustrating a supply pipe 353 and a discharge pipe 354 connected to the supply port 355 and the discharge port 356 of the chamber 301, respectively, and FIG. 16B is a cross-sectional view taken along the XVIb-XVIb line in FIG. 16A. The supply port 355 and the discharge port 356 are provided to oppose each other in the end portions of the element substrate 12. The supply port 355 and the discharge port 356 are openings formed by the two walls 352 and the element substrate 12 and the lid substrate 351, while the supply port 355 is provided to be able to supply the liquid to the chamber 301 and the discharge port 356 is provided to be able to discharge the liquid from the chamber 301. The supply pipe 353 is connected with the supply port 355, and the discharge pipe 354 is connected with the discharge port 356. Since the pair of the supply port 355 and the discharge port 356 and the pair of the supply pipe 353 and the discharge pipe 354 respectively have the same configurations, they are interchangeable.

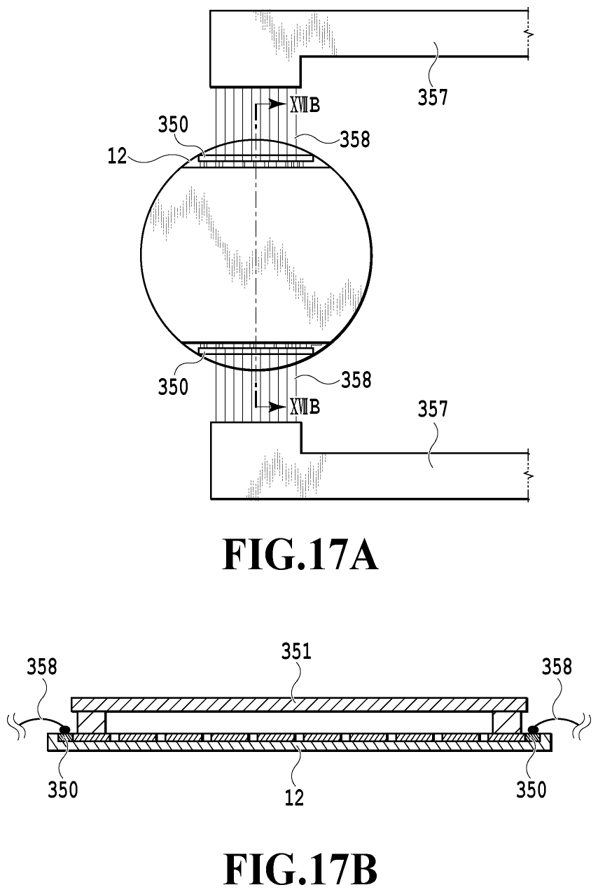

FIG. 17A is a diagram illustrating the state where the element substrate 12 and flexible wiring substrates 357 are electrically connected with each other, and FIG. 17B is a cross-sectional view taken along the XVIIb-XVIIb line in FIG. 17A. The supply pipe 353 and the discharge pipe 354 are omitted in FIGS. 17A and 17B. The element substrate 12 is electrically connected with the flexible wiring substrates 357 through the electrode pads 350, and the electrode pads 350 and wirings of the flexible wiring substrates 357 are connected with each other through wire bondings 358.

With the chamber 301 formed as described above, it is possible to generate the film boiling bubble 13 in a region of the liquid in contact with the heating element 10 by applying a predetermined voltage pulse to the heating element 10 on the bottom surface of the chamber 301, and to generate the ultrafine bubbles along with the expansion and shrinkage of the film boiling bubble 13.

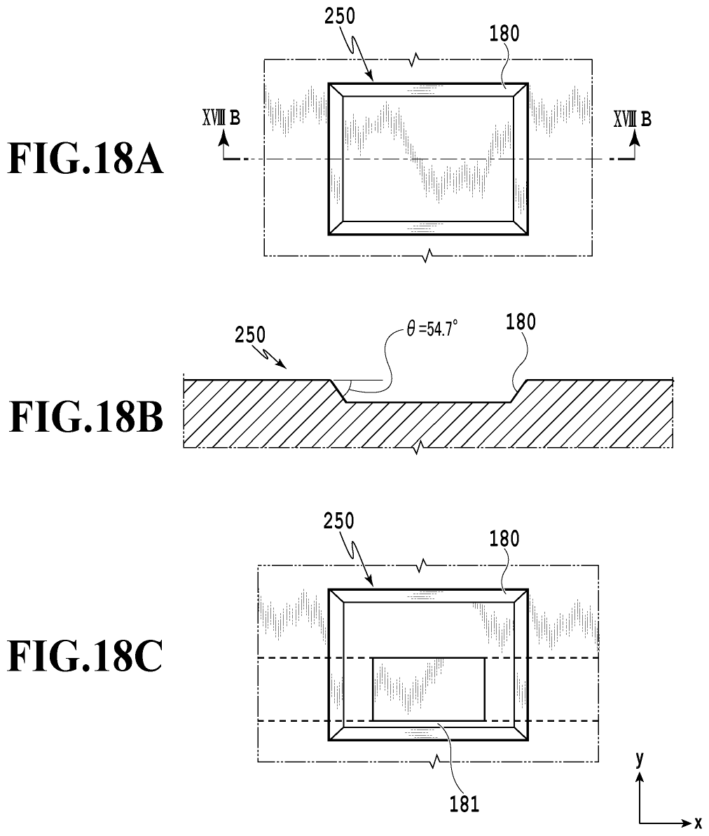

FIGS. 18A to 18C are diagrams illustrating a heater part 250 provided with the heating element 10 in the element substrate 12 of this embodiment. In FIGS. 18A and 18B, illustration of the heating element 10 is omitted. FIG. 18A is a diagram illustrating a recess portion 180 of the heater part 250, and FIG. 18B is a cross-sectional view taken along the XVIIIb-XVIIIb line in FIG. 18A. In the element substrate 12 of this embodiment, the recess portion 180 is formed in a portion in which the heating element 10 is provided. The recess portion 180 of the element substrate 12 is a rectangular recess portion 180 as illustrated in FIGS. 18A and 18C, and a cross section thereof is in a trapezoidal shape having inclined surfaces at an angle of θ=54.7° as illustrated in FIG. 18B. The recess portion 180 is formed by anisotropic etching a silicon substrate <1.0.0>. In the recess portion 180, the heating element 10 is provided in a position displaced in a −y direction from the center of the recess portion 180 as illustrated in FIG. 18C.

The heating element 10 is not put in contact with the inclined surfaces of the recess portion 180 in the −y direction, and between one of the inclined surfaces of the recess portion 180 and the heating element 10, there is a bubble-disappearance position 181 in which the bubble 13 generated by driving the heating element 10 disappears.

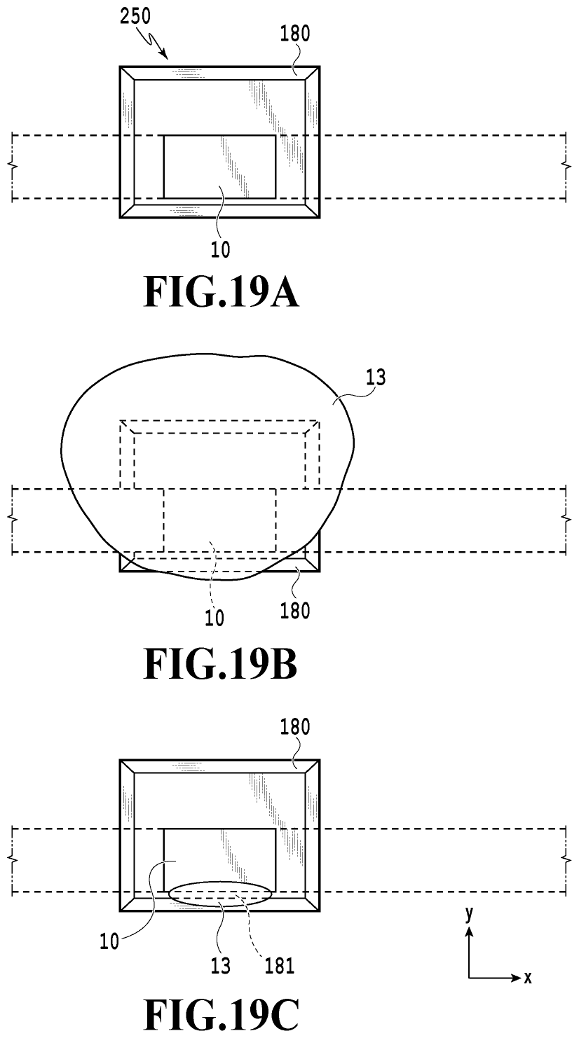

FIGS. 19A to 19C are diagrams illustrating states of bubbling in the liquid over time while driving the heating element 10 of this embodiment. FIG. 19A illustrates a state before driving the heating element 10, and no bubbling occurs in the liquid yet. FIG. 19B illustrates a state where the bubbling occurs in the liquid by driving the heating element 10, and during the bubbling, a direction in which the bubble 13 expands is restricted by the recess portion 180, and the bubble 13 is formed while expanding largely in the y direction. This is because the inclined surfaces of the recess portion 180 in positions in an x direction, a −x direction, and the −y direction from the heating element 10 are provided closely to the heating element 10 as walls, but the inclined surface of the recess portion 180 in a position in they direction from the heating element 10 is provided at a predetermined distance from the heating element 10.

With this configuration, during the bubbling, the bubble 13 is less likely to be affected by the inclined surface of the recess portion 180 in the y direction, but is likely to be affected by the inclined surfaces of the recess portion 180 positioned in the x, −x, and −y directions from the heating element 10. Thus, the bubble 13 grows while expanding largely in the y direction in which the bubble 13 is less likely to be affected by the inclined surface. Thereafter, in the process of bubble disappearance, the bubble 13 is affected by the recess portion 180 and quickly shrinks in the −y direction, which is opposite to the case of bubbling, as illustrated in FIG. 19C. Consequently, the bubble 13 disappears in the bubble-disappearance position 181 in a region having a predetermined area, which is a position displaced in the −y direction from the heating element 10.

In general, in the case where the bubble generated by driving the heating element disappears, the surrounding liquids collide with each other in the center of the bubble at the moment of the disappearance, and so-called cavitation that generates a tiny but strong pressure wave (shock wave) thus occurs. If the cavitation occurs repeatedly on the heating element while using the apparatus continuously, the heating element may be damaged by being hit by the shock waves repeatedly.

To deal with this, in the UFB generating apparatus of this embodiment, the shape of the bubble 13 generated by driving the heating element 10 is restricted by the recess portion 180, and the bubble-disappearance position 181 in which the bubble 13 disappears is in the position displaced in the −y direction from the heating element 10. The bubble-disappearance position 181 has a predetermined area, and the area is the maximum area that can keep the effect of the cavitation within that area during the bubble disappearance, which prevents the cavitation during the bubble disappearance from affecting the adjacent heating element 10. This area varies depending on the size of the heating element and the driving voltage to be used, and thus the area may be set appropriately to be fit for the apparatus.

This makes it possible to suppress the effect of the cavitation on the heating element 10 during the bubble disappearance. Thus, it is possible to obtain a reliable UFB generating apparatus that suppresses the damage of the heating element 10 by setting the bubble-disappearance position 181 in which the bubble 13 disappears in a position other than where the heating element 10 is positioned.

Although the heating element 10 is arranged in the position displaced in the −y direction from the center of the recess portion 180 in this embodiment, the embodiment is not limited thereto. That is, the heating element 10 may be arranged in any position as long as the position in which the heating element 10 is arranged is displaced from the center of the recess portion 180 and the position is other than the bubble-disappearance position 181 in which the bubble 13 disappears, the bubble-disappearance position 181 being displaced from the heating element 10.

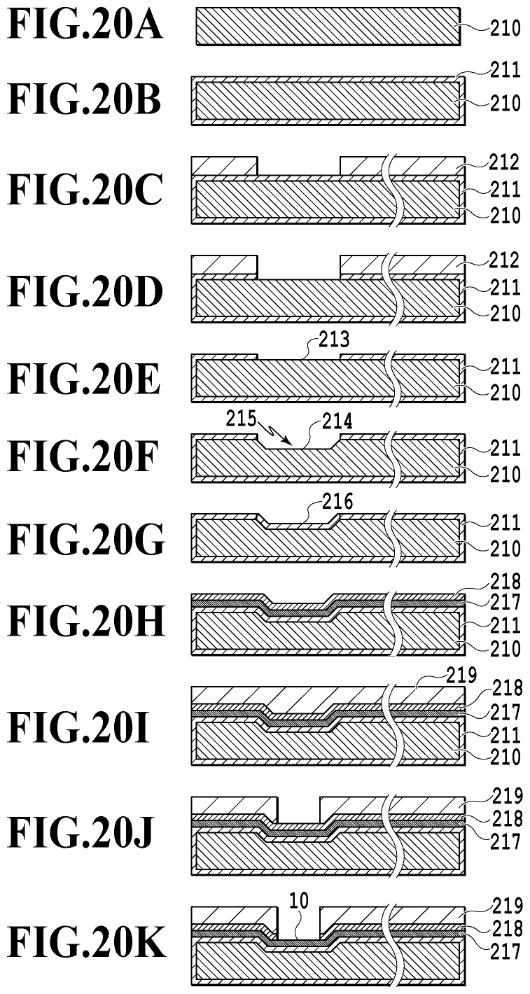

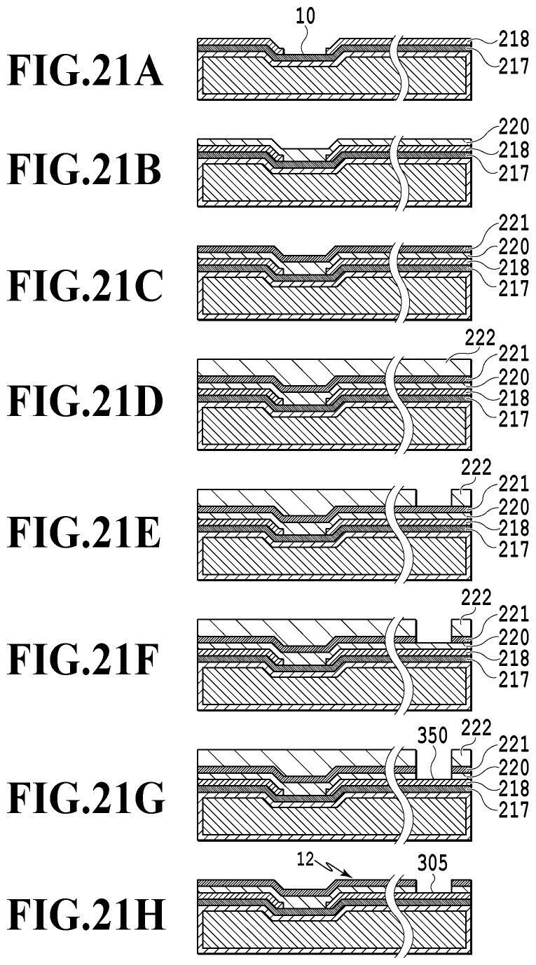

FIGS. 20A to 20K and FIGS. 21A to 21H are diagrams illustrating steps of forming the element substrate 12 in the order of the steps. Hereinafter, a method of forming the element substrate 12 in this embodiment is described in the order of the steps. The method of mounting the heating element 10 and so on on the substrate described herein is similar to the conventional method. First, as illustrated in FIG. 20A, a silicon substrate <1.0.0> 210 in the form of a wafer to be used as the element substrate 12 is prepared. As illustrated in FIG. 20B, an oxide film 211 of 1 μm is formed as a heat storage layer for the top surface of the silicon substrate 210 and as a protection film for the back surface thereof by processing at a temperature of 1200° C. for 70 minutes under an oxidation atmosphere condition using water vapor by a thermal oxidation furnace. Thereafter, as illustrated in FIG. 20C, a photoresist 212 manufactured by TOKYO OHKAKOGYO CO., LTD. is applied in a thickness of 2 μm by spin coating. Then, a glass mask for exposure in a predetermined shape is used to perform exposure with an i-line stepper FPA-3000i5 manufactured by Canon, and the resist 212 in a region corresponding to the portion in which the heating element 10 is to be arranged is removed to form an opening.

Then, as illustrated in FIG. 20D, the oxide film 211 in the opening is removed by dry etching using a mixed gas of CF4 and O2. As illustrated in FIG. 20E, the substrate is immersed in a resist delamination liquid remover 1112A manufactured by Rohm and Haas Company to delaminate and remove the resist 212. Subsequently, as illustrated in FIG. 20F, the substrate in the state of FIG. 20E is immersed in an alkali etching liquid at 80° C. as a TMAH22% aqueous solution for 40 minutes to form a recess portion 215 with a depth of 3 μm from an opening 213 including a surface 214. The recess portion 215 includes flat and smooth surfaces having tapers at an angle of 54.7 degrees from the opening of the oxide film 211 and the surface 214 as a bottom surface, and the surface 214 is formed as a flat surface on which the heating element 10 can be arranged.

Thereafter, the substrate in the state of FIG. 20F is processed for 300 minutes under an oxidation atmosphere condition using water vapor to form an oxide film 216 of 2 μm in thickness on the silicon top surface of the recess portion 215 as illustrated in FIG. 20G. Then, a TaSiN resistance layer 217 of 30 nm in thickness is formed on the substrate in the state of FIG. 20G and subsequently an Al-wiring layer 218 of 500 nm in thickness as a wiring material is formed on the TaSiN resistance layer 217 by spattering (see FIG. 20H). Thereafter, the TaSiN resistance layer 217 and the Al-wiring layer 218 are formed in predetermined shapes by photolithography. Specifically, first, as illustrated in FIG. 20I, a photoresist 219 manufactured by TOKYO OHKA KOGYO CO., LTD. is applied in a thickness of 2 μm by spin coating (see FIG. 20I), and then, a glass mask for exposure in a predetermined shape is used to perform exposure with an i-line stepper FPA-3000i5 manufactured by Canon. Thereafter, development is performed, and the resist 219 is left in a shape of the wiring 308 as illustrated in FIG. 13A (see FIG. 20J).

Subsequently, the Al-wiring layer 218 and the TaSiN resistance layer 217 are etched simultaneously by reactive-ion etching using a BCl3 gas and a Cl2 gas to form a wiring portion. In this process, the Al-wiring layer 218 and the TaSiN resistance layer 217 are arranged in a position displaced from the center of the recess portion 215. Thereafter, as a step of forming a heater, the heating element 10 is formed by partially removing the Al-wiring layer 218 and exposing the TaSiN resistance layer 217 by wet etching using phosphate in the recess portion 215 (see FIG. 20K). This makes it possible to displace the position in which the bubble 13 generated by driving the heating element 10 disappears from the top of the heating element 10. Thereafter, as illustrated in FIG. 21A, the substrate in the state of FIG. 20K is immersed in the resist delamination liquid remover 1112A to delaminate and remove the resist 219.

Next, a protection layer and a cavitation-resistant film for insulating the heating element 10 and the wiring 308 from the liquid and protecting them from heat and impact of the bubbling are formed. As illustrated in FIG. 21B, a film 220 of silicon nitride (hereinafter, written as SiN) is formed in a thickness of 500 nm by plasma CVD. Then, a metal Ir film 221 is formed in a thickness of 200 nm on the SiN film 220 by spattering as illustrated in FIG. 21C. The SiN film 220 is the protection layer for electric insulation from the liquid, and the metal Ir film 221 has particularly a function of the cavitation-resistant film protecting the heating element 10 from heating in the heating element 10 and from an impact from bubbling and bubble disappearance, that is, cavitation.

Thereafter, the SiN film 220 and the metal Ir film 221 are formed in predetermined shapes by photolithography. Specifically, as illustrated in FIG. 21D, a photoresist 222 manufactured by TOKYO OHKA KOGYO CO., LTD. is applied in a thickness of 2 μm by spin coating, and then, a glass mask for exposure in a predetermined shape is used to perform exposure with the i-line stepper FPA-3000i5. Thereafter, development is performed, and the resist 222 is partially removed as illustrated in FIG. 21E to leave the resist 222 in a predetermined shape. Subsequently, the metal Ir film 221 in the portion from which the resist 222 is removed is etched by reactive-ion etching using CF4 as illustrated in FIG. 21F. The SiN film 220 is etched subsequently as illustrated in FIG. 21G, and the electrode pad 350 for the connection with the external wiring is formed. At last, the substrate in the state of FIG. 21G is immersed in the resist delamination liquid remover 1112A to delaminate and remove the resist 222, and the element substrate 12 including the heating element 10, the electrode pad 350, and the recess portion 180 is completed as illustrated in FIG. 21H.

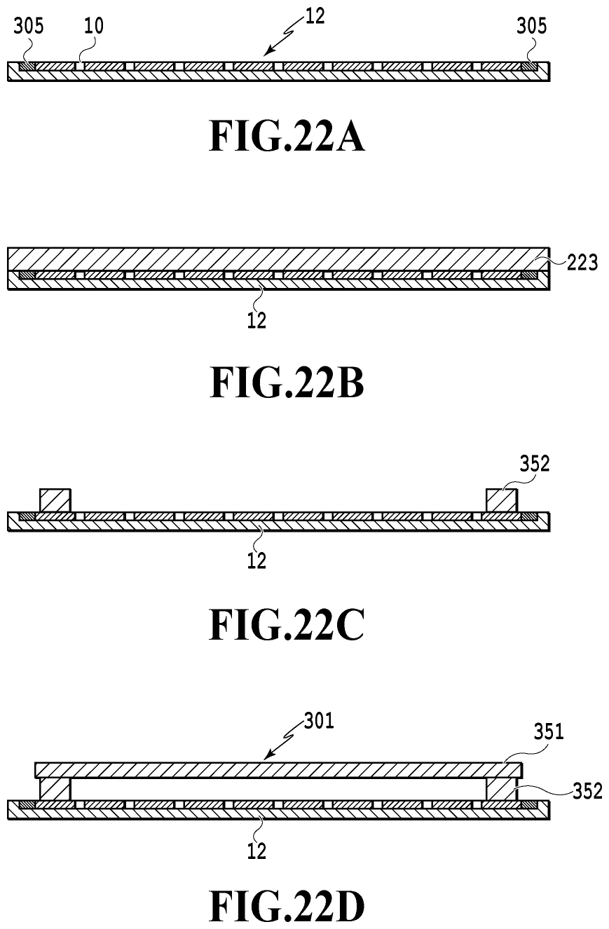

FIGS. 22A to 22D are diagrams illustrating steps of forming the chamber 301 in the order of the steps. Hereinafter, a method of forming the chamber 301 in this embodiment is described in the order of the steps. The element substrate 12 as illustrated in FIG. 7A is prepared, and thereafter, as illustrated in FIG. 22B, a member 223 to be the walls 352 is applied to have a predetermined thickness by spin coating, and then the walls 352 are formed by photolithography as illustrated in FIG. 22C. Thereafter, the chamber 301 is formed by attaching the lid substrate 351 to the walls 352.

In this embodiment, although the recess portion is formed on the element substrate by etching and the heating element is formed on the bottom surface of the recess portion, the embodiment is not limited thereto. That is, the heating element may be formed to be exposed on the top surface of the substrate, and then walls of a predetermined height may be formed around the heating element by a method such as laminating films.

As described above, the growth of the bubble during the bubbling is partially restricted by forming the walls around the heating element, and the position in which the bubble disappears is displaced from the heating element. This makes it possible to efficiently generate a UFB-containing liquid with high purity and to provide an ultrafine bubble generating apparatus and an ultrafine bubble generating method that can extend the lifetime of the apparatus additionally.

### Second Embodiment

Hereinafter, a second embodiment of the present invention is described with reference to the drawings. Since the basic configuration of this embodiment is similar to the configuration of the first embodiment, only characteristic configurations are described below.

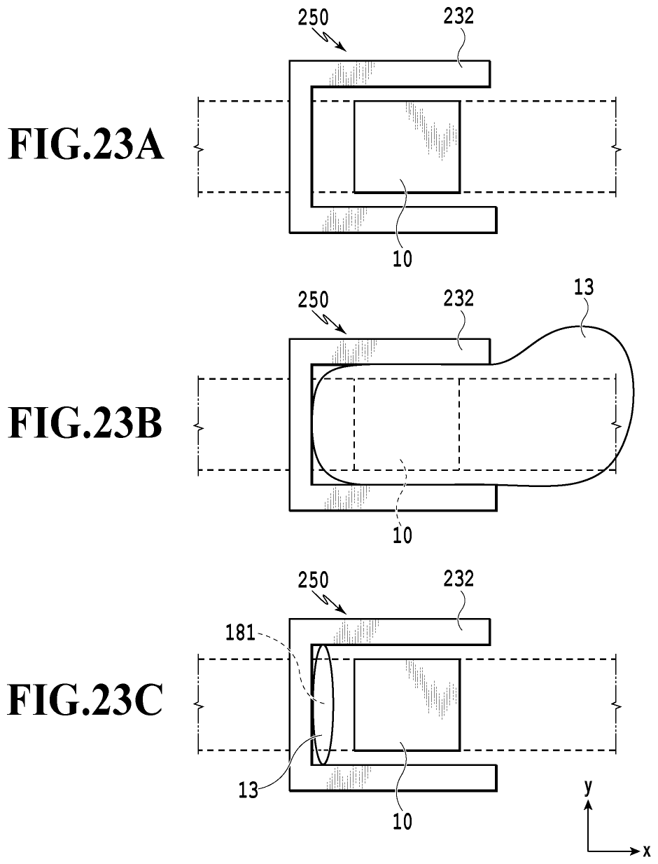

FIGS. 23A to 23C are diagrams illustrating the heater part 250 in the element substrate 12 of this embodiment. As illustrated in FIG. 23A, the heater part 250 in this embodiment is provided with walls 232, which are restriction members that restrict the growth of the bubble 13 in three directions (y direction, −y direction, −x direction) around the heating element 10 during the bubbling. Although the recess portion 180 is formed by digging the substrate by etching in the first embodiment, there is no recess portion formed by digging the substrate in this embodiment. The walls 232 are formed in the three directions around the heating element 10 as illustrated in FIG. 23A by laminating films on the substrate having the top surface on which the heating element 10 is exposed. A region having a predetermined area is formed adjacent to the heating element in a direction other than the three directions.

With the walls 232 provided in the three directions around the heating element 10 as described above, the growth in the surrounding three directions of the bubble 13 generated by driving the heating element 10 is restricted by the walls 232, and the bubble 13 grows while expanding largely in the x direction in which the walls 232 are not provided. The bubble 13 grown while expanding largely in the x direction as illustrated in FIG. 23B then starts shrinking, and disappears in the bubble-disappearance position 181 displaced in the −x direction from the heating element 10 as illustrated in FIG. 23C. With the bubble 13 disappearing in the bubble-disappearance position 181 that is a position displaced from the heating element 10 as described above, it is possible to suppress the effect of the cavitation on the heating element 10 during the bubble disappearance, and thus the damage on the heating element can be suppressed. Consequently, it is possible to obtain a reliable UFB generating apparatus.

Although the method of forming the walls 232 in the three direction around the heating element by laminating the films is described in this embodiment, the embodiment is not limited thereto. That is, the wall may be formed in at least a part of the surroundings of the heating element 10. With the wall formed in at least a part of the surroundings of the heating element 10 like this, the growth of the bubble in the direction in which the wall is formed is restricted during the bubbling, and a bubble that grows while expanding in a direction opposite to the direction in which the wall is provided is formed. In the shrinkage, the bubble that has grown while expanding in the direction opposite to the direction in which the wall is provided quickly shrinks in the direction from the heating element toward the wall, which is opposite to the case of bubbling. Consequently, the bubble-disappearance position is displaced from the top of the heating element, and the bubble disappears in the bubble-disappearance position between the wall and the heating element. This makes it possible to suppress the effect of the cavitation on the heating element 10 during the bubble disappearance.

Although no wall is provided in the x direction from the heating element 10 in this embodiment, the wall in the x direction may be formed with a region (second region) provided between the heating element 10 and the wall in the x direction, the second region being wider than a region (first region) between the heating element 10 and the wall 232 in the −x direction. With the wall in the x direction provided like this, the bubble to be generated is likely to be affected more by the wall in the −x direction than the wall in the x direction, and thus it is possible to control the bubble to grow while expanding in the x direction.

### Third Embodiment

Hereinafter, a third embodiment of the present invention is described with reference to the drawings. Since the basic configuration of this embodiment is similar to the configuration of the first embodiment, only characteristic configurations are described below.

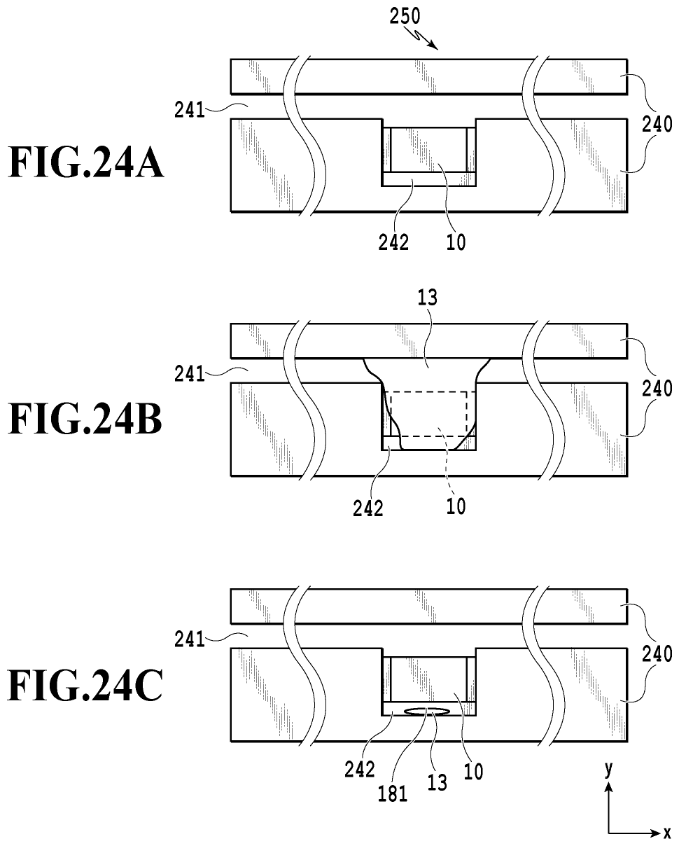

FIGS. 24A to 24C are diagrams illustrating the heater part 250 in the element substrate 12 of this embodiment. The heater part 250 of this embodiment is provided with walls 240 around the heating element 10 to form a recess portion 242 in which a flow passage 241 and the heating element 10 are provided. Like the second embodiment, the substrate is not dug in this embodiment as well, and the walls 240 as illustrated in FIG. 24A are formed by laminating films on the substrate having the top surface on which the heating element 10 is exposed. The walls in the three directions (−x direction, −y direction, x direction) around the heating element 10 are formed integrally. With the walls 240 formed like this, the liquid that has flowed through the flow passage 241 flows into the recess portion 242, and the bubbling occurs by the heating element 10 heating the liquid. In this process, since there is the recess portion 242 formed by the walls 240 in the three directions (−x direction, −y direction, x direction) around the heating element 10, the growth in the three directions of the bubble 13 is restricted, and the bubble 13 grows while expanding toward the flow passage 241. As illustrated in FIG. 24B, the grown bubble 13 largely expanding in a flow passage direction (y direction) then starts shrinking, and disappears in the bubble-disappearance position 181 displaced in the −y direction from the heating element 10 as illustrated in FIG. 24C. With the bubble 13 disappearing in the bubble-disappearance position 181 displaced from the heating element 10 as described above, it is possible to suppress the effect of the cavitation on the heating element 10 during the bubble disappearance, and thus the damage on the heating element 10 can be suppressed. Consequently, it is possible to obtain a reliable UFB generating apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-036508 filed Feb. 28, 2019, which is hereby incorporated by reference wherein in its entirety.

What is claimed is:

1. An ultrafine bubble generating apparatus that generates ultrafine bubbles, comprising:
an element substrate that includes
a plurality of heaters that generate the ultrafine bubbles by heating a liquid and
a wiring connected with the heaters, wherein
a restriction member that restricts a growth of a bubble generated by an action of each heater is included at least in a part of surroundings of the heater, and
a first region having a predetermined area is provided between the restriction member and the heater.

2. The ultrafine bubble generating apparatus according to claim 1, wherein
a second region having an area wider than that of the first region is provided adjacent to the heater on a side opposing the restriction member with respect to the heater.

3. The ultrafine bubble generating apparatus according to claim 1, wherein
the restriction member is formed by digging the element substrate which is a silicon substrate by etching.

4. The ultrafine bubble generating apparatus according to claim 2, wherein the restriction member is formed by laminating films.

5. The ultrafine bubble generating apparatus according to claim 4, wherein
the restriction member includes a first restriction member including the first region between the first restriction member and the heater, and second restriction members facing each other with the heater arranged therebetween.

6. The ultrafine bubble generating apparatus according to claim 5, wherein
the first restriction member and the second restriction members are formed integrally, and
the ultrafine bubble generating apparatus further comprises:
a third restriction member provided to face the first restriction member, wherein
a flow passage that includes the second region and allows the liquid to flow therethrough is formed between the integrally formed first restriction member and second restriction member and the third restriction member.

7. The ultrafine bubble generating apparatus according to claim 1, wherein
a cavitation-resistant film that protects the heater from a shock wave generated by cavitation is formed on the heater.

8. The ultrafine bubble generating apparatus according to claim 1, wherein
a chamber that forms a space containing the heater is formed on the element substrate.

9. The ultrafine bubble generating apparatus according to claim 8, wherein
the chamber includes
an electrode pad that is provided in an end portion of the element substrate to enable a connection of an external wiring outside the element substrate with the wiring,
a supply port, and
a drain port, wherein
the liquid is allowed to be supplied from a supply pipe connected with the supply port to the chamber, and the liquid in the chamber is allowed to be discharged from a drain pipe connected with the drain port.

10. The ultrafine bubble generating apparatus according to claim 1, wherein
the element substrate is a substrate in a form of a wafer that is formed by slicing a single crystal ingot.

11. An ultrafine bubble generating method for generating ultrafine bubbles, comprising:
a process of forming a heater on a substrate;
a process of bringing the heater into contact with a liquid;
a process of driving the heater;
a process of restricting a growth of a bubble generated by an action of the heater by a restriction member at least in a part of surroundings of the heater; and
a process of making the bubble disappear in a region having a predetermined area between the restriction member and the heater.
